(19) United States
(12) Patent Application Publication
(10) Pub. No.: US 2023/0369681 A1
(43) Pub. Date: Nov. 16, 2023

(54) THERMAL INSULATION MATERIALS FOR BATTERIES

(71) Applicant: Hollingsworth & Vose Company, East Walpole, MA (US)

(72) Inventor: Zhiping Jiang, Nashua, NH (US)

(73) Assignee: Hollingsworth & Vose Company, East Walpole, MA (US)

(21) Appl. No.: 17/744,503

(22) Filed: May 13, 2022

(51) Int. Cl. H01M 10/658; H01M 10/651; D04H 1/4218; D04H 1/732; D04H 1/4391; D04H 1/58

(52) U.S. Cl. CPC H01M 10/658; H01M 10/651; D04H 1/4218; D04H 1/732; D04H 1/4391; D04H 1/58; D10B 2505/00

(57) ABSTRACT

Thermal insulation materials for batteries are generally described. The thermal insulation materials described herein have a number of advantages. For example, in some embodiments, the thermal insulation materials have desirable thermal properties, such as low thermal conductivity and/or high thermal stability. As another example, in some embodiments, the thermal insulation materials described herein have desirable structural properties, such as having a relatively low thickness, and/or beneficial mechanical properties. The thermal insulation materials described herein may also have a combination of desirable thermal and structural properties.

### TECHNICAL FIELD

Articles and associated systems and methods for thermal insulation of batteries are generally described.

### BACKGROUND

Electrochemical cells such as lithium-ion electrochemical cells or electrochemical cells with lithium metal anodes can overheat or catch fire during use. If a battery comprising a plurality of electrochemical cells does not include appropriate thermal insulation, heat and/or fire that is generated in one electrochemical cell may undesirably spread to others, which can cause a safety hazard and/or diminish overall battery performance. Accordingly, improved thermal insulation materials are needed.

### SUMMARY

Thermal insulation materials for batteries are generally described. The subject matter of the present disclosure involves, in some cases, interrelated products, alternative solutions to a particular problem, and/or a plurality of different uses of one or more systems and/or articles.

In one aspect, a battery is provided. In some embodiments, the battery comprises: a plurality of electrochemical cells comprising a first electrochemical cell and a second electrochemical cell; and a non-woven fiber web positioned between the first and second electrochemical cells, wherein: the non-woven fiber web comprises glass fibers; the glass fibers comprise high softening point fibers that comprise less than or equal to 0.8 wt % Na₂O and/or less than or equal to 0.8 wt % K₂O; the high softening point fibers make up greater than or equal to 30 wt % of the glass fibers; the glass fibers make up greater than 80 wt % of the non-woven fiber web; and the glass fibers have an average length that is greater than or equal to 0.5 mm and less than or equal to 7 mm.

In another aspect, a battery is provided. In some embodiments, the battery comprises: a plurality of electrochemical cells comprising a first electrochemical cell and a second electrochemical cell; and a wet laid non-woven fiber web positioned between the first and second electrochemical cells, wherein: the non-woven fiber web comprises glass fibers; the glass fibers comprise high softening point fibers that comprise that comprise less than or equal to 0.8 wt % Na₂O and/or less than or equal to 0.8 wt % K₂O; and the high softening point fibers make up greater than or equal to 30 wt % of the glass fibers; and the glass fibers make up greater than 80 wt % of the non-woven fiber web.

In yet another aspect, a battery is provided. In some embodiments, the battery comprises: a plurality of modules comprising a first module and a second module; and a non-woven fiber web positioned between the first and second modules, wherein: the non-woven fiber web comprises glass fibers; the glass fibers comprise high softening point fibers that comprise less than or equal to 0.8 wt % Na₂O and/or less than or equal to 0.8 wt % K₂O; the high softening point fibers make up greater than or equal to 30 wt % of the glass fibers; the glass fibers make up greater than 80 wt % of the non-woven fiber web; and the glass fibers have an average length that is greater than or equal to 0.5 mm and less than or equal to 7 mm.

In still another aspect, a battery is provided. In some embodiments, the battery comprises: a plurality of modules comprising a first module and a second module; and a wet laid non-woven fiber web positioned between the first and second modules, wherein: the non-woven fiber web comprises glass fibers; the glass fibers comprise high softening point fibers that comprise that comprise less than or equal to 0.8 wt % Na₂O and/or less than or equal to 0.8 wt % K₂O; and the high softening point fibers make up greater than or equal to 30 wt % of the glass fibers; and the glass fibers make up greater than 80 wt % of the non-woven fiber web.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 presents a top-view schematic of a nonlimiting non-woven fiber web, according to some embodiments;

FIG. 2A presents a side-view schematic of a non-woven fiber web positioned between a first electrochemical cell and a second electrochemical cell, according to some embodiments;

FIG. 2B presents a cross-sectional schematic of a nonlimiting battery comprising more than two electrochemical cells and more than one non-woven fiber web, according to some embodiments;

FIG. 3 presents a cross-sectional schematic of a non-woven fiber web positioned between a first module and a second module, according to some embodiments;

FIG. 4 presents a scanning electron micrograph of a non-woven fiber web, according to some embodiments;

FIG. 5 presents a scanning electron micrograph of a non-woven fiber web, according to some embodiments;

FIG. 6 presents a scanning electron micrograph of a non-woven fiber web, according to some embodiments

FIG. 7 presents a scanning electron micrograph of a non-woven fiber web, according to some embodiments.

FIG. 8 presents a scanning electron micrograph of a non-woven fiber web, according to some embodiments;

FIG. 9 presents a scanning electron micrograph of a non-woven fiber web, according to some embodiments;

FIG. 10 presents a scanning electron micrograph of a non-woven fiber web, according to some embodiments; and

FIG. 11 presents a scanning electron micrograph of a non-woven fiber web, according to some embodiments.

### DETAILED DESCRIPTION

Thermal insulation materials for batteries are generally described. The thermal insulation materials described herein have a number of advantages. For example, in some embodiments, the thermal insulation materials have desirable thermal properties, such as low thermal conductivity and/or high thermal stability. As another example, in some embodiments, the thermal insulation materials described herein have desirable structural properties, such as having a relatively low thickness, and/or beneficial mechanical properties. The thermal insulation materials described herein may also have a combination of desirable thermal and structural properties.

In some embodiments, a thermal insulation material takes the form of a non-woven fiber web. A non-woven fiber web may comprise one or more components that is advantageous for use in a thermal insulation material. In other words, a non-woven fiber web may comprise a combination of components that cause a non-woven fiber web, as a whole, to exhibit one or more of the beneficial thermal properties described herein. For example, a non-woven fiber web may comprise high softening point fibers, which may advantageously enhance the thermostability of a non-woven fiber web and/or decrease its shrinkage at high temperatures. As another example, a non-woven fiber web may comprise useful additives, such as a fire retardants and/or aerogels.

In some embodiments, a non-woven fiber web that serves as a thermal insulation material comprises one or more further components in addition to the components that improve the thermal properties. For instance, a thermal insulation material may comprise one or more components that enhance a structural property and/or a mechanical property of a non-woven fiber web. Such components may comprise fibers, such as glass fibers other than high softening point fibers and/or synthetic fibers.

Some non-woven fiber webs described herein have low thicknesses. Without wishing to be bound by any particular theory, it is believed that such non-woven fiber webs may be desirable for preserving the energy density of a battery in which they are positioned. Some such non-woven fiber webs may be wet laid non-woven fiber webs and/or may comprise relatively short fibers. Also without wishing to be bound by any particular theory, it is believed that wet laying may be particularly suitable for forming particularly thin non-woven fiber webs, such as non-woven fiber webs that are thinner than those that may be formed employing other techniques, such as air laying. It is also believed that fibers that are relatively short may facilitate wet laying.

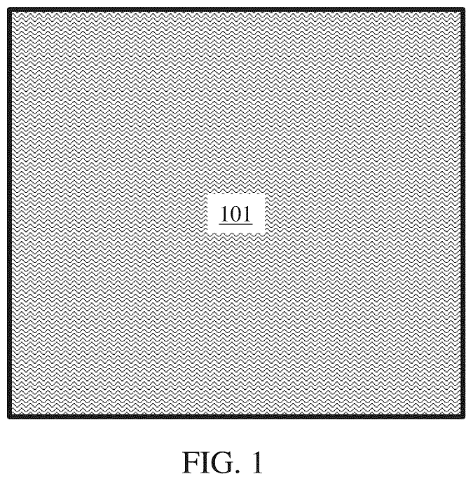

FIG. 1 presents a top-view schematic of a nonlimiting non-woven fiber web 101. Some non-woven fiber webs may be configured to inhibit the flow of heat between electrochemical cells of a battery, thereby improving battery performance and/or safety. For instance, as described in further detail elsewhere herein, a non-woven fiber web may have a particularly low thermal conductivity and/or comprise one or more fire retardants.

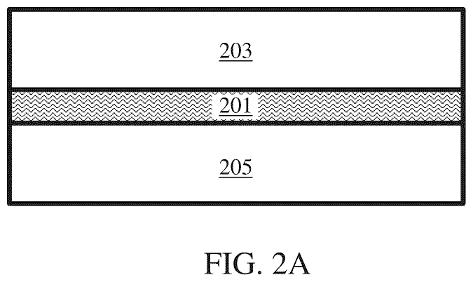

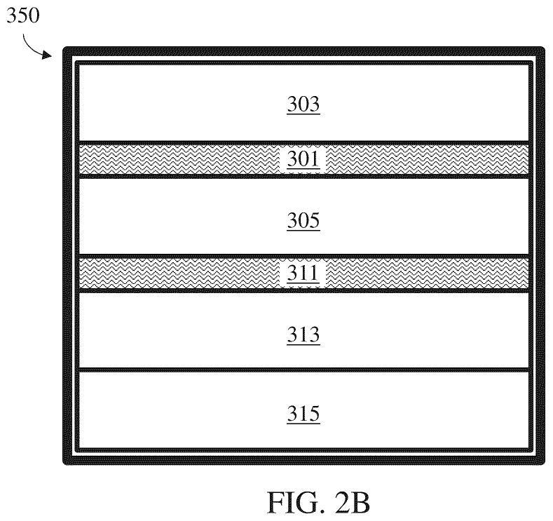

In some embodiments, a non-woven fiber web is positioned in a battery. As an example, a non-woven fiber web may be positioned between two electrochemical cells present in a battery. FIG. 2A presents a nonlimiting side-view schematic of a non-woven fiber web 201 positioned between a first electrochemical cell 203 and a second electrochemical cell 205. The non-woven fiber web 201 may directly contact at least a portion of the first electrochemical cell 203 and/or the second electrochemical cell 205, as shown in FIG. 2A, or may be separated from one or both of the electrochemical cells 203 and 205 by one or more intervening materials (not shown). For example, in some embodiments, a non-woven fiber web may be separated from an electrochemical cell by an intervening material that is able to undergo a relatively high degree of compression (e.g., a compressible foam) and/or that can accommodate dimensional changes (e.g., expansion, contraction) during charge and/or discharge of the electrochemical cell.

In some embodiments, a non-woven fiber web is positioned in a battery comprising more than two electrochemical cells. In some such embodiments, a battery may comprise multiple non-woven fiber webs positioned between multiple pairs of electrochemical cells. FIG. 2B presents a cross-sectional schematic of a nonlimiting battery 350 comprising more than two electrochemical cells and more than one non-woven fiber web. As shown in FIG. 2B, the battery 350 comprises a first non-woven fiber web 301 (separating a first electrochemical cell 303 from a second electrochemical cell 305) and a second non-woven fiber web 311 (separating second electrochemical cell 305 from a third electrochemical cell 313). As also shown in FIG. 2B, in some embodiments, it is possible for some pairs of nearest neighbor electrochemical cells to have a non-woven fiber web positioned therebetween and for some pairs of nearest neighbor electrochemical cells to not have a non-woven fiber web positioned therebetween. It is also possible for all of the nearest neighbor electrochemical cells in a battery to have a non-woven fiber web positioned therebetween.

As used herein, nearest neighbor electrochemical cells are electrochemical cells positioned in a common stack that are not separated by other electrochemical cells. The electrochemical cells at the end of a stack have one nearest neighbor electrochemical cell and electrochemical cells in the middle of a stack have two nearest neighbor electrochemical cells. For instance, with reference to FIG. 2B, the electrochemical cell 313 has two nearest neighbor electrochemical cells: the electrochemical cell 305 (from which it is separated by the non-woven fiber web 311) and the electrochemical cell 315 (from which it is not separated by a non-woven fiber web). As another example, and also with reference to FIG. 2B, the electrochemical cell 315 has one nearest neighbor electrochemical cell: the electrochemical cell 313.

In some embodiments, a battery comprises a plurality of modules. Generally, each module comprises a plurality of electrochemical cells, such as those described elsewhere herein. In some embodiments, all or a majority of the electrochemical cells of a battery are positioned in a module present in the battery. The plurality of electrochemical cells present in a module may be mechanically coupled to one another via the module. A module may comprise one or more non-woven fiber webs. Such non-woven fiber webs may be positioned between electrochemical cells present in the module. In some embodiments, a battery comprises modules that do not comprise a non-woven fiber web. For example, in some embodiments, a battery comprises no modules that comprise a non-woven fiber web. It is also possible for a battery to comprise some modules that comprise a non-woven fiber web and others that do not.

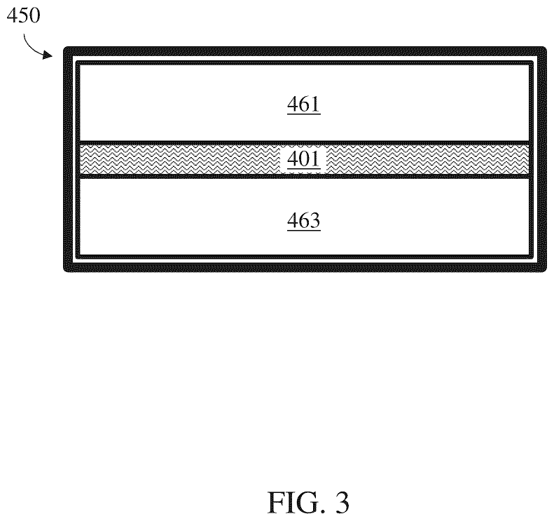

In some embodiments, a battery comprises a non-woven fiber web positioned between two modules present therein. FIG. 3 schematically shows such a battery (the battery 450). In FIG. 3, the non-woven fiber web 401 is positioned between the modules 461 and 463. The non-woven fiber web 401 may directly contact at least a portion of the first module 461 and/or the second module 463, as shown in FIG. 3, or may be separated from one or both of the modules 461 and 463 by one or more intervening materials (not shown).

A non-woven fiber web positioned between two modules present in a battery may both separate modules and separate electrochemical cells present in different modules. As one example, a non-woven fiber web positioned between two modules may, by separating the modules from each other, also separate the electrochemical cells present in the modules from each other. Such non-woven fiber webs may thereby separate a first electrochemical cell belonging to the first module from a second electrochemical cell belonging to the second module.

In some embodiments, a non-woven fiber web is positioned in a battery comprising more than two modules. In some such embodiments, a battery may comprise multiple non-woven fiber webs positioned between multiple pairs of modules. In some embodiments, it is possible for some pairs of nearest neighbor modules to have a non-woven fiber web positioned therebetween and for some pairs of nearest neighbor modules to not have a non-woven fiber web positioned therebetween. It is also possible for all of the nearest neighbor modules in a battery to have a non-woven fiber web positioned therebetween.

As used herein, nearest neighbor modules are modules positioned in a common battery that are not separated by other modules. In some embodiments, modules may be stacked to form one or more stacks. The modules at the end of a stack have one nearest neighbor module in its stack and one nearest neighbor in each stack to which it is adjacent. The modules in the middle of a stack have two nearest neighbor modules in their stacks and one nearest neighbor module in each stack to which they are adjacent.

In some embodiments, non-woven fiber webs may be disposed in a battery in a manner other than that shown in FIGS. 2A, 2B, and 3. For example, a non-woven fiber web may be folded such that a first portion of the non-woven fiber web separates a first pair of nearest neighbor electrochemical cells, and a second portion of the non-woven fiber web separates a second pair of nearest neighbor electrochemical cells. As another example, a battery may comprise a non-woven fiber web that is folded such that it winds between the electrochemical cells of the battery in a serpentine configuration. Similarly, non-woven fiber webs may be folded such that they comprise a first portion separating a first pair of nearest neighbor modules and a second portion separating a second pair of nearest neighbor modules and/or may be folded such that they wind between modules in a battery in a serpentine configuration.

It should, of course, be understood that although battery 350 of FIG. 2B and the battery 450 of FIG. 3 have stacked configurations, generally, batteries in which a non-woven fiber web described herein is positioned may comprise electrochemical cells and modules in any of a variety of spatial configurations, such as laterally offset or wound electrochemical cell configurations, and the disclosure is not so limited.

A non-woven fiber web described herein may comprise glass fibers. The glass fibers may be included in any of a variety of appropriate amounts. In some embodiments, a non-woven fiber web comprises glass fibers in an amount of greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than 80 wt %, or greater than or equal to 85 wt % versus the total weight of the fiber web. In some embodiments, a non-woven fiber web comprises glass fibers in an amount of less than or equal to 100 wt %, less than or equal to 95 wt %, less than or equal to 90 wt %, less than or equal to 85 wt %, less than or equal to 80 wt %, less than or equal to 75 wt %, or less than or equal to 70 wt % versus the total weight of the fiber web. Combinations of these ranges are also possible (e.g., greater than or equal to 50 wt % and less than or equal to 100 wt %, greater than or equal to 65 wt % and less than or equal to 100 wt %, or greater than or equal to 80 wt % and less than or equal to 100 wt % versus the total weight of the fiber web). In some embodiments, glass fibers make up 100 wt % of a non-woven fiber web.

Glass fibers may have any of a variety of appropriate average fiber diameters. In some embodiments, a non-woven fiber web comprises glass fibers having an average diameter of greater than or equal to 1 micron, greater than or equal to 2 microns, greater than or equal to 3 microns, greater than or equal to 4 microns, greater than or equal to 5 microns, greater than or equal to 6 microns, greater than or equal to 7 microns, or greater than or equal to 8 microns. In some embodiments, a non-woven fiber web comprises glass fibers having an average diameter of less than or equal to 20 microns, less than or equal to 19 microns, less than or equal to 18 microns, less than or equal to 17 microns, less than or equal to 16 microns, less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, less than or equal to 7 microns, less than or equal to 6 microns, or less than or equal to 5 microns. Combinations of these ranges are also possible (e.g., greater than or equal to 1 micron and less than or equal to 20 microns, greater than or equal to 1 micron and less than or equal to 13 microns, greater than or equal to 3 microns and less than or equal to 10 microns, or greater than or equal to 4 microns and less than or equal to 8 microns). Other ranges are also possible.

A non-woven fiber web described herein may comprise glass fibers having any of a variety of suitable average lengths. In some embodiments, a non-woven fiber web comprises glass fibers having an average length of greater than or equal to 0.5 mm, greater than or equal to 0.6 mm, greater than or equal to 0.7 mm, greater than or equal to 0.8 mm, greater than or equal to 0.9 mm, greater than or equal to 1 mm, greater than or equal to 2 mm, greater than or equal to 3 mm, greater than or equal to 4 mm, greater than or equal to 5 mm, greater than or equal to 6 mm, greater than or equal to 7 mm, or greater than or equal to 8 mm. In some embodiments, a non-woven fiber web comprises glass fibers having an average length of less than or equal to 15 mm, less than or equal to 14 mm, less than or equal to 13 mm, less than or equal to 12 mm, less than or equal to 11 mm, less than or equal to 10 mm, less than or equal to 9 mm, less than or equal to 8 mm, less than or equal to 7 mm, less than or equal to 6 mm, or less than or equal to 5 mm. Combinations of these ranges are also possible (e.g., greater than or equal to 0.5 mm and less than or equal to 15 mm, greater than or equal to 1 mm and less than or equal to 11 mm, greater than or equal to 2 mm and less than or equal to 9 mm, or greater than or equal to 3 mm and less than or equal to 7 mm). Other ranges are also possible.

This disclosure recognizes that some glass fibers, such as those having high thermal stability (referred to herein as high softening point fibers), may provide a number of advantages when incorporated into non-woven fiber webs for use in thermal insulation materials. For example, high softening point fibers may be less prone to softening and/or shrinkage upon heating, as described in greater detail below. High softening point fibers may comprise silicate, alumina, or aluminosilicate glasses with any of a variety of suitable chemical compositions.

The present disclosure recognizes that, in accordance with some embodiments, it may be advantageous for high softening point fibers to comprise relatively small amounts of alkali metal oxides, such as sodium oxides and/or potassium oxides. Without wishing to be bound by any particular theory, sodium and potassium may disrupt a network of covalent bonds within aluminosilicate glasses, thereby reducing their thermal stability and their softening point. In some embodiments, Na₂O is present in a high softening point fiber in an amount of less than or equal to 0.8 wt %, less than or equal to 0.7 wt %, less than or equal to 0.6 wt %, less than or equal to 0.5 wt %, less than or equal to 0.4 wt %, or less than or equal to 0.3 wt % versus the total weight of the high softening point fiber. In some embodiments, Na₂O is present in a high softening point fiber in an amount of greater than or equal to 0.1 wt %, greater than or equal to 0.2 wt %, greater than or equal to 0.3 wt %, greater than or equal to 0.4 wt %, greater than or equal to 0.5 wt %, or greater than or equal to 0.6 wt % versus the total weight of the high softening point fiber. Combinations of these ranges are also possible (e.g., greater than or equal to 0.1 wt % and less than or equal to 0.8 wt %, greater than or equal to 0.1 wt % and less than or equal to 0.6 wt %, or greater than or equal to 0.1 wt % and less than or equal to 0.5 wt % versus the total weight of the high softening point fiber). Other ranges are also possible.

In some embodiments, K₂O is present in a high softening point fiber in an amount of less than or equal to 0.8 wt %, less than or equal to 0.75 wt %, less than or equal to 0.7 wt %, less than or equal to 0.65 wt %, less than or equal to 0.6 wt %, less than or equal to 0.55 wt %, less than or equal to 0.5 wt %, less than or equal to 0.45 wt %, or less than or equal to 0.4 wt % versus the total weight of the high softening point fiber. In some embodiments, K₂O is present in a high softening point fiber in an amount of greater than or equal to 0 wt % greater than or equal to 0.05 wt %, greater than or equal to 0.1 wt %, greater than or equal to 0.15 wt %, greater than or equal to 0.2 wt %, greater than or equal to 0.25 wt %, or greater than or equal to 0.3 wt % versus the total weight of the high softening point fiber. Combinations of these ranges are also possible (e.g., greater than or equal to 0 wt % and less than or equal to 0.8 wt %, greater than or equal to 0.05 wt % and less than or equal to 0.6 wt %, or greater than or equal to 0.05 wt % and less than or equal to 0.5 wt % versus the total weight of the high softening point fiber). Other ranges are also possible. In some embodiments, K₂O is present in a high softening point fiber in an amount of 0 wt %.

Relatively low amounts of boron may be associated with advantageously high softening points. A non-woven fiber web may comprise a high softening point fiber having any of a variety of suitable amounts of B₂O₃. In some embodiments, B₂O₃ is present in a high softening point fiber in an amount of less than or equal to 10 wt %, less than or equal to 9 wt %, less than or equal to 8 wt %, less than or equal to 7 wt %, less than or equal to 6 wt %, less than or equal to 5 wt %, less than or equal to 4 wt %, less than or equal to 3 wt %, or less than or equal to 2 wt % versus the total weight of the high softening point fiber. In some embodiments, B₂O₃ is present in a high softening point fiber in an amount of greater than or equal to 0 wt %, greater than or equal to 1 wt %, greater than or equal to 2 wt %, greater than or equal to 3 wt %, or greater than or equal to 4 wt % versus the total weight of the high softening point fiber. Combinations of these ranges are also possible (e.g., greater than or equal to 0 wt % and less than or equal to 10 wt %, greater than or equal to 0 wt % and less than or equal to 7 wt %, or greater than or equal to 0 wt % and less than or equal to 2 wt % versus the total weight of the high softening point fiber). Other ranges are also possible. In some embodiments, B₂O₃ is present in a high softening point fiber in an amount of 0 wt %.

In some embodiments, high softening point fibers may comprise glasses of the types commercially known as E-glass or ECR-glass. Further details regarding possible compositions for high softening point fibers are provided below.

A high softening point fiber, such as an E-glass fiber or an ECR-glass fiber may comprise any of a variety of compounds. For example, a non-woven fiber web may comprise a high softening point fiber having any of a variety of suitable amounts of SiO₂. In some embodiments, SiO₂ is present in a high softening point fiber in an amount of greater than or equal to 50 wt %, greater than or equal to 51 wt %, greater than or equal to 52 wt %, greater than or equal to 53 wt %, greater than or equal to 54 wt %, greater than or equal to 55 wt %, greater than or equal to 56 wt %, greater than or equal to 57 wt %, greater than or equal to 58 wt %, greater than or equal to 59 wt %, greater than or equal to 60 wt %, greater than or equal to 61 wt %, greater than or equal to 62 wt %, greater than or equal to 63 wt %, greater than or equal to 64 wt %, greater than or equal to 65 wt %, greater than or equal to 66 wt %, greater than or equal to 67 wt %, greater than or equal to 68 wt %, or greater than or equal to 69 wt % versus the total weight of the high softening point fiber. In some embodiments, SiO₂ is present in the high softening point fiber in an amount of less than or equal to 70 wt %, less than or equal to 69 wt %, less than or equal to 68 wt %, less than or equal to 67 wt %, less than or equal to 66 wt %, less than or equal to 65 wt %, less than or equal to 64 wt %, less than or equal to 63 wt %, less than or equal to 62 wt %, less than or equal to 61 wt %, or less than or equal to 60 wt % versus the total weight of the high softening point fiber. Combinations of these ranges are also possible (e.g., greater than or equal to 50 wt % and less than or equal to 70 wt %, greater than or equal to 50 wt % and less than or equal to 65 wt %, greater than or equal to 55 wt % and less than or equal to 64 wt %, or greater than or equal to 60 wt % and less than or equal to 64 wt % versus the total weight of the high softening point fiber). Other ranges are also possible.

A non-woven fiber web may comprise a high softening point fiber having any of a variety of suitable amounts of Al₂O₃. In some embodiments, Al₂O₃ is present in a high softening point fiber in an amount of greater than or equal to 6 wt %, greater than or equal to 7 wt %, greater than or equal to 8 wt %, greater than or equal to 9 wt %, greater than or equal to 10 wt %, or greater than or equal to 11 wt % versus the total weight of the high softening point fiber. In some embodiments, Al₂O₃ is present in a high softening point fiber in an amount of less than or equal to 16 wt %, less than or equal to 15 wt %, less than or equal to 14 wt %, less than or equal to 13 wt %, less than or equal to 12 wt %, or less than or equal to 11 wt % versus the total weight of the high softening point fiber. Combinations of these ranges are also possible (e.g., greater than or equal to 6 wt % and less than or equal to 16 wt %, greater than or equal to 8 wt % and less than or equal to 15 wt %, or greater than or equal to 10 wt % and less than or equal to 14 wt % versus the total weight of the high softening point fiber). Other ranges are also possible.

A non-woven fiber web may comprise a high softening point fiber having any of a variety of suitable amounts of CaO. In some embodiments, CaO is present in a high softening point fiber in an amount of greater than or equal to 15 wt %, greater than or equal to 16 wt %, greater than or equal to 17 wt %, greater than or equal to 18 wt %, greater than or equal to 19 wt %, or greater than or equal to 20 wt % versus the total weight of the high softening point fiber. In some embodiments, CaO is present in a high softening point fiber in an amount of less than or equal to 25 wt %, less than or equal to 24 wt %, less than or equal to 23 wt %, less than or equal to 22 wt %, less than or equal to 21 wt %, or less than or equal to 20 wt % versus the total weight of the high softening point fiber. Combinations of these ranges are also possible (e.g., greater than or equal to 15 wt % and less than or equal to 25 wt %, greater than or equal to 17 wt % and less than or equal to 23 wt %, or greater than or equal to 19 wt % and less than or equal to 21 wt % versus the total weight of the high softening point fiber). Other ranges are also possible.

A non-woven fiber web may comprise a high softening point fiber having any of a variety of suitable amounts of MgO. In some embodiments, MgO is present in a high softening point fiber in an amount of greater than or equal to 0 wt %, greater than or equal to 0.1 wt %, greater than or equal to 0.2 wt %, greater than or equal to 0.5 wt %, greater than or equal to 1 wt %, or greater than or equal to 2 wt % versus the total weight of the high softening point fiber. In some embodiments, MgO is present in a high softening point fiber in an amount of less than or equal to 5 wt %, less than or equal to 4.5 wt %, less than or equal to 4 wt %, less than or equal to 3.5 wt %, less than or equal to 3 wt %, less than or equal to 2.5 wt %, or less than or equal to 2 wt % versus the total weight of the high softening point fiber. Combinations of these ranges are also possible (e.g., greater than or equal to 0 wt % and less than or equal to 5 wt %, greater than or equal to 0.1 wt % and less than or equal to 4 wt %, or greater than or equal to 0.2 wt % and less than or equal to 2.5 wt % versus the total weight of the high softening point fiber). Other ranges are also possible. In some embodiments, MgO is present in a high softening point fiber in an amount of 0 wt %.

A non-woven fiber web may comprise a high softening point fiber having any of a variety of suitable amounts of ZnO. In some embodiments, ZnO is present in a high softening point fiber in an amount of greater than or equal to 0 wt %, greater than or equal to 0.1 wt %, greater than or equal to 0.2 wt %, greater than or equal to 0.3 wt %, greater than or equal to 0.4 wt %, or greater than or equal to 0.5 wt % versus the total weight of the high softening point fiber. In some embodiments, ZnO is present in a high softening point fiber in an amount of less than or equal to 1 wt %, less than or equal to 0.9 wt %, less than or equal to 0.8 wt %, less than or equal to 0.7 wt %, less than or equal to 0.6 wt %, less than or equal to 0.5 wt %, less than or equal to 0.4 wt %, less than or equal to 0.3 wt %, or less than or equal to 0.2 wt % versus the total weight of the high softening point fiber. Combinations of these ranges are also possible (e.g., greater than or equal to 0 wt % and less than or equal to 1 wt %, greater than or equal to 0 wt % and less than or equal to 0.5 wt %, or greater than or equal to 0 wt % and less than or equal to 0.2 wt % versus the total weight of the high softening point fiber). Other ranges are also possible. In some embodiments, ZnO is present in a high softening point fiber in an amount of 0 wt %.

A non-woven fiber web may comprise a high softening point fiber having any of a variety of suitable amounts of TiO₂. In some embodiments, TiO₂ is present in a high softening point fiber in an amount of greater than or equal to 0.2 wt %, greater than or equal to 0.3 wt %, greater than or equal to 0.4 wt %, greater than or equal to 0.5 wt %, greater than or equal to 0.8 wt %, or greater than or equal to 1 wt % versus the total weight of the high softening point fiber. In some embodiments, TiO₂ is present in a high softening point fiber in an amount of less than or equal to 2.5 wt %, less than or equal to 2.2 wt %, less than or equal to 2 wt %, less than or equal to 1.8 wt %, less than or equal to 1.5 wt %, less than or equal to 1.2 wt %, less than or equal to 1 wt %, less than or equal to 0.8 wt %, or less than or equal to 0.5 wt % versus the total weight of the high softening point fiber. Combinations of these ranges are also possible (e.g., greater than or equal to 0.2 wt % and less than or equal to 2.5 wt %, greater than or equal to 0.2 wt % and less than or equal to 1 wt %, or greater than or equal to 0.2 wt % and less than or equal to 0.5 wt % versus the total weight of the high softening point fiber). Other ranges are also possible.

A non-woven fiber web may comprise a high softening point fiber having any of a variety of suitable amounts of Fe₂O₃. In some embodiments, Fe₂O₃ is present in a high softening point fiber in an amount of greater than or equal to 0 wt %, greater than or equal to 0.1 wt %, greater than or equal to 0.2 wt %, greater than or equal to 0.3 wt %, or greater than or equal to 0.4 wt % versus the total weight of the high softening point fiber. In some embodiments, Fe₂O₃ is present in a high softening point fiber in an amount of less than or equal to 0.5 wt %, less than or equal to 0.4 wt %, less than or equal to 0.3 wt %, or less than or equal to 0.2 wt % versus the total weight of the high softening point fiber. Combinations of these ranges are also possible (e.g., greater than or equal to 0 wt % and less than or equal to 0.5 wt %, greater than or equal to 0 wt % and less than or equal to 0.4 wt %, or greater than or equal to 0 wt % and less than or equal to 0.3 wt % versus the total weight of the high softening point fiber). Other ranges are also possible. In some embodiments, Fe₂O₃ is present in a high softening point fiber in an amount of 0 wt %.

A non-woven fiber web may comprise a high softening point fiber having any of a variety of suitable amounts of F. In some embodiments, F is present in a high softening point fiber in an amount of greater than or equal to 0 wt %, greater than or equal to 0.01 wt %, greater than or equal to 0.02 wt %, greater than or equal to 0.05 wt %, greater than or equal to 0.075 wt %, greater than or equal to 0.1 wt %, greater than or equal to 0.15 wt %, greater than or equal to 0.2 wt %, or greater than or equal to 0.25 wt % versus the total weight of the high softening point fiber. In some embodiments, F is present in a high softening point fiber in an amount of less than or equal to 0.3 wt %, less than or equal to less than or equal to 0.25 wt %, less than or equal to 0.2 wt %, less than or equal to 0.15 wt %, less than or equal to 0.075 wt %, less than or equal to 0.05 wt %, less than or equal to 0.02 wt %, or less than or equal to 0.01 wt % versus the total weight of the high softening point fiber. Combinations of these ranges are also possible (e.g., greater than or equal to 0 wt % and less than or equal to 0.3 wt %). Other ranges are also possible. In some embodiments, F is present in a high softening point fiber in an amount of 0 wt %.

A non-woven fiber web described herein may comprise high softening point fibers having any of a variety of suitable softening points. In some embodiments, a non-woven fiber web comprises high softening point fibers having a softening point of greater than or equal to 800° C., greater than or equal to 825° C., greater than or equal to 850° C., greater than or equal to 875° C., greater than or equal to 900° C., greater than or equal to 925° C., or greater than or equal to 950° C. In some embodiments, a non-woven fiber web comprises high softening point fibers having a softening point of less than or equal to 1,000° C., less than or equal to 975° C., less than or equal to 950° C., less than or equal to 925° C., or less than or equal to 900° C. Combinations of these ranges are also possible (e.g., greater than or equal to 800° C. and less than or equal to 1,000° C., greater than or equal to 850° C. and less than or equal to 1,000° C., or greater than or equal to 900° C. and less than or equal to 1,000° C.). Other ranges are also possible. The softening point of high softening point fibers may be determined in accordance with ASTM C338-1993.

A non-woven fiber web described herein may comprise high softening point fibers in any of a variety of suitable amounts. In some embodiments, a non-woven fiber web comprises high softening point fibers in an amount of greater than or equal to 30 wt %, greater than or equal to 35 wt %, greater than 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, or greater than or equal to 70 wt % versus the total weight of the non-woven fiber web. In some embodiments, a non-woven fiber web comprises high softening point fibers in an amount of less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, or less than or equal to 40 wt % versus the total weight of the non-woven fiber web. Combinations of these ranges are also possible (e.g., greater than or equal to 30 wt % and less than or equal to 75 wt %, greater than or equal to 35 wt % and less than or equal to 65 wt %, or greater than or equal to 40 wt % and less than or equal to 60 wt % versus the total weight of the non-woven fiber web). Other ranges are also possible.

In some embodiments, a non-woven fiber web comprises high softening point fibers in an amount of greater than or equal to 35 wt %, greater than 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, or greater than or equal to 80 wt % versus the total weight of the glass fibers in the non-woven fiber web. In some embodiments, a non-woven fiber web comprises high softening point fibers in an amount of less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, or less than or equal to 50 wt % versus the total weight of the glass fibers in the non-woven fiber web. Combinations of these ranges are also possible (e.g., greater than or equal to 35 wt % and less than or equal to 85 wt %, greater than or equal to 40 wt % and less than or equal to 70 wt %, or greater than or equal to 45 wt % and less than or equal to 65 wt % versus the total weight of the glass fibers in the non-woven fiber web). Other ranges are also possible.

A non-woven fiber web described herein may comprise high softening point fibers having any of a variety of suitable diameters. In some embodiments, a non-woven fiber web comprises high softening point fibers having an average diameter of greater than or equal to 2 microns, greater than or equal to 3 microns, greater than or equal to 4 microns, greater than or equal to 5 microns, greater than or equal to 6 microns, greater than or equal to 7 microns, or greater than or equal to 8 microns. In some embodiments, a non-woven fiber web comprises high softening point fibers having an average diameter of less than or equal to 13 microns, less than or equal to 12 microns, less than or equal to 11 microns, less than or equal to 10 microns, less than or equal to 9 microns, less than or equal to 8 microns, less than or equal to 7 microns, less than or equal to 6 microns, or less than or equal to 5 microns. Combinations of these ranges are also possible (e.g., greater than or equal to 3 microns and less than or equal to 13 microns, greater than or equal to 4 microns and less than or equal to 10 microns, or greater than or equal to 5 microns and less than or equal to 8 microns). Other ranges are also possible.

A non-woven fiber web described herein may comprise high softening point fibers having any of a variety of suitable lengths. In some embodiments, a non-woven fiber web comprises high softening point fibers having an average length of greater than or equal to 3 mm, greater than or equal to 4 mm, greater than or equal to 5 mm, greater than or equal to 6 mm, greater than or equal to 7 mm, or greater than or equal to 8 mm. In some embodiments, a non-woven fiber web comprises high softening point fibers having an average length of less than or equal to 13 mm, less than or equal to 12 mm, less than or equal to 11 mm, less than or equal to 10 mm, less than or equal to 9 mm, less than or equal to 8 mm, less than or equal to 7 mm, less than or equal to 6 mm, or less than or equal to 5 mm. Combinations of these ranges are also possible (e.g., greater than or equal to 3 mm and less than or equal to 13 mm, greater than or equal to 4 mm and less than or equal to 10 mm, or greater than or equal to 5 mm and less than or equal to 8 mm). Other ranges are also possible.

In some embodiments, a non-woven fiber web comprises chopped strand glass fibers. The chopped strand glass fibers may comprise chopped strand glass fibers which were produced by drawing a melt of glass from bushing tips into continuous fibers and then cutting the continuous fibers into short fibers. Some chopped strand glass fibers may comprise fibers that have relatively monodispersed fiber diameters and/or may comprise two or more populations of fibers that each have relatively monodispersed fiber diameters. Some chopped strand glass fibers may be relatively straight. In some embodiments, chopped strand glass fibers are provided (e.g., to a furnish) in the form that is relatively unentangled.

In some embodiments, a non-woven fiber web comprises chopped strand glass fibers that are high softening point fibers. It is also possible for a non-woven fiber web to comprise chopped strand glass fibers that are not high softening point fibers. It should be understood that chopped strand glass fibers present in a non-woven fiber web may comprise one or more of the types of chopped strand glass fibers described herein.

In some embodiments, a non-woven fiber web comprises chopped strand glass fibers in an amount of greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, or greater than or equal to 70 wt % versus the total weight of the non-woven fiber web. In some embodiments, a non-woven fiber web comprises chopped strand glass fibers in an amount of less than or equal to 75 wt %, less than or equal to 70 wt %, less than or equal to 65 wt %, less than or equal to 60 wt %, less than or equal to 55 wt %, less than or equal to 50 wt %, or less than or equal to 45 wt % versus the total weight of the non-woven fiber web. Combinations of these ranges are also possible (e.g., greater than or equal to 30 wt % and less than or equal to 75 wt %, greater than or equal to 35 wt % and less than or equal to 65 wt %, or greater than or equal to 45 wt % and less than or equal to 60 wt % versus the total weight of the non-woven fiber web). Other ranges are also possible.

A non-woven fiber web described herein may comprise chopped strand glass fibers having any of a variety of suitable diameters. In some embodiments, a non-woven fiber web comprises chopped strand glass fibers having an average diameter of greater than or equal to 2 microns, greater than or equal to 3 microns, greater than or equal to 4 microns, greater than or equal to 5 microns, greater than or equal to 6 microns, greater than or equal to 7 microns, or greater than or equal to 8 microns. In some embodiments, a non-woven fiber web comprises chopped strand glass fibers having an average diameter of less than or equal to 13 microns, less than or equal to 12 microns, less than or equal to 11 microns, less than or equal to 10 microns, less than or equal to 9 microns, less than or equal to 8 microns, less than or equal to 7 microns, less than or equal to 6 microns, or less than or equal to 5 microns. Combinations of these ranges are also possible (e.g., greater than or equal to 3 microns and less than or equal to 13 microns, greater than or equal to 4 microns and less than or equal to 10 microns, or greater than or equal to 5 microns and less than or equal to 8 microns). Other ranges are also possible.

A non-woven fiber web described herein may comprise chopped strand glass fibers having any of a variety of suitable lengths. In some embodiments, a non-woven fiber web comprises chopped strand glass fibers having an average length of greater than or equal to 3 mm, greater than or equal to 4 mm, greater than or equal to 5 mm, greater than or equal to 6 mm, greater than or equal to 7 mm, or greater than or equal to 8 mm. In some embodiments, a non-woven fiber web comprises chopped strand glass fibers having an average length of less than or equal to 13 mm, less than or equal to 12 mm, less than or equal to 11 mm, less than or equal to 10 mm, less than or equal to 9 mm, less than or equal to 8 mm, less than or equal to 7 mm, less than or equal to 6 mm, or less than or equal to 5 mm. Combinations of these ranges are also possible (e.g., greater than or equal to 3 mm and less than or equal to 13 mm, greater than or equal to 4 mm and less than or equal to 10 mm, or greater than or equal to 5 mm and less than or equal to 8 mm). Other ranges are also possible.

The non-woven fiber web may comprise staple glass fibers. Staple glass fibers may be formed by drawing a melt of glass from bushing tips and then subjecting the drawn melt of glass to subjected to flame blowing or rotary spinning (e.g., centrifugal spinning) processes. Some staple glass fibers may have relatively broad fiber diameter distributions. Some staple fibers may be relatively curled. In some embodiments, chopped strand glass fibers are provided (e.g., to a furnish) in the form that is relatively entangled. Without wishing to be bound by theory, in some embodiments curled staple glass fibers may assist with entangling the fibers in the fiber web (e.g., other staple glass fibers, chopped strand glass fibers, multicomponent fibers). This entanglement may improve the mechanical properties of a non-woven fiber web by mechanically supporting the fibers in the non-woven fiber web.

Additionally, in some embodiments, a non-woven fiber web comprises staple glass fibers that are high softening point fibers. Accordingly, staple glass fibers, when present, may have some or all of the properties described above with respect to high softening point fibers (e.g., composition, softening point, wt % versus the total weight of glass fibers in the non-woven fiber web, average diameter, diameter, average length). It is also possible for a non-woven fiber web to comprise staple glass fibers that are not high softening point fibers.

In some embodiments, a non-woven fiber web comprises staple glass fibers in an amount of greater than or equal to 15 wt %, greater than or equal to 20 wt %, greater than or equal to 25 wt %, greater than or equal to 30 wt %, greater than or equal to 35 wt %, greater than or equal to 40 wt %, or greater than or equal to 45 wt % versus the total weight of the non-woven fiber web. In some embodiments, a non-woven fiber web comprises staple glass fibers in an amount of less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, or less than or equal to 20 wt % versus the total weight of the non-woven fiber web. Combinations of these ranges are also possible (e.g., greater than or equal to 15 wt % and less than or equal to 55 wt %, greater than or equal to 25 wt % and less than or equal to 50 wt %, or greater than or equal to 30 wt % and less than or equal to 45 wt % versus the total weight of the non-woven fiber web). Other ranges are also possible.

A non-woven fiber web described herein may comprise staple glass fibers having any of a variety of suitable diameters. In some embodiments, a non-woven fiber web comprises staple glass fibers having an average diameter of greater than or equal to 0.4 microns, greater than or equal to 0.5 microns, greater than or equal to 0.6 microns, greater than or equal to 0.7 microns, greater than or equal to 0.8 microns, greater than or equal to 0.9 microns, greater than or equal to 1 micron, greater than or equal to 2 microns, greater than or equal to 3 microns, greater than or equal to 4 microns, greater than or equal to 5 microns, or greater than or equal to 6 microns. In some embodiments, a non-woven fiber web comprises staple glass fibers having an average diameter of less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, less than or equal to 2 microns, less than or equal to 1 micron, less than or equal to 0.9 microns, less than or equal to 0.8 microns, less than or equal to 0.7 microns, less than or equal to 0.6 microns, or less than or equal to 0.5 microns. Combinations of these ranges are also possible (e.g., greater than or equal to 0.4 microns and less than or equal to 10 microns, greater than or equal to 1 micron and less than or equal to 9 microns, greater than or equal to 2 microns and less than or equal to 7 microns, or greater than or equal to 3 microns and less than or equal to 5 microns). Other ranges are also possible.

A non-woven fiber web may comprise staple glass fibers that are relatively polydisperse. In some embodiments, a non-woven fiber web comprises staple glass fibers (possibly having an average fiber diameter in one or more of the above-described ranges) and comprises at least some staple glass fibers having a diameter of greater than or equal to 0.3 microns, greater than or equal to 0.4 microns, greater than or equal to 0.5 microns, greater than or equal to 0.6 microns, greater than or equal to 0.7 microns, greater than or equal to 0.8 microns, greater than or equal to 0.9 microns, greater than or equal to 1 micron, greater than or equal to 1.5 microns, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, greater than or equal to 12 microns, or greater than or equal to 13 microns. In some embodiments, a non-woven fiber web comprises staple glass fibers (possibly having an average fiber diameter in one or more of the above-described ranges) and comprises at least some staple glass fibers having a diameter of less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, less than or equal to 2 microns, less than or equal to 1.5 microns, less than or equal to 1 micron, less than or equal to 0.9 microns, less than or equal to 0.8 microns, less than or equal to 0.7 microns, less than or equal to 0.6 microns, or less than or equal to 0.5 microns. Combinations of these ranges are also possible (e.g., greater than or equal to 0.3 microns and less than or equal to 15 microns, greater than or equal to 0.3 microns and less than or equal to 4 microns, greater than or equal to 7 microns and less than or equal to 15 microns, or greater than or equal to 3 microns and less than or equal to 11 microns). Other ranges are also possible.

A non-woven fiber web described herein may comprise staple glass fibers having any of a variety of suitable lengths. In some embodiments, a non-woven fiber web comprises staple glass fibers having an average length of greater than or equal to 0.5 mm, greater than or equal to 0.6 mm, greater than or equal to 0.7 mm, greater than or equal to 0.8 mm, greater than or equal to 0.9 mm, greater than or equal to 1 mm, greater than or equal to 1.2 mm, greater than or equal to 1.5 mm, greater than or equal to 1.7 mm, greater than or equal to 2 mm, greater than or equal to 2.2 mm, greater than or equal to 2.5 mm, or greater than or equal to 2.8 mm. In some embodiments, a non-woven fiber web comprises staple glass fibers having an average length of less than or equal to 3 mm, less than or equal to 2.8 mm, less than or equal to 2.5 mm, less than or equal to 2.2 mm, less than or equal to 2 mm, less than or equal to 1.8 mm, less than or equal to 1.5 mm, less than or equal to 1 mm, less than or equal to 0.9 mm, less than or equal to 0.8 mm, less than or equal to 0.7 mm, or less than or equal to 0.6 mm. Combinations of these ranges are also possible (e.g., greater than or equal to 0.5 mm and less than or equal to 3 mm, greater than or equal to 1 mm and less than or equal to 2.5 mm, greater than or equal to 1.2 mm and less than or equal to 2.2 mm, or greater than or equal to 1.5 mm and less than or equal to 2 mm). Other ranges are also possible.

In some embodiments, a non-woven fiber web comprises staple glass fibers that are microglass fibers. Accordingly, microglass fibers, when present, may have some or all of the properties described above with respect to staple fibers (e.g., wt % versus the total weight of the non-woven fiber web, average length). It is also possible for a non-woven fiber web to comprise staple glass fibers that are not microglass fibers (in addition to and/or instead of staple glass fibers that are microglass fibers). In some embodiments, a non-woven fiber web comprises microglass fibers in a weight percentage of greater than or equal to 0 wt %, greater than or equal to 25 wt %, greater than or equal to 50 wt %, or greater than or equal to 75 wt % versus the total weight of the staple glass fibers in the non-woven web. In some embodiments, a non-woven fiber web comprises microglass fibers in a weight percentage of less than or equal to 100 wt %, less than or equal to 75 wt %, less than or equal to 50 wt %, or less than or equal to 25 wt % versus the total weight of the staple glass fibers in the non-woven web. Combinations of these ranges are also possible (e.g., greater than or equal to 0 wt % and less than or equal to 100 wt %). Other ranges are also possible. In some embodiments, microglass fibers make up 0 wt % of the staple glass fibers in a non-woven fiber web. In some embodiments, microglass fibers make up 100 wt % of the staple glass fibers in a non-woven fiber web.

Microglass fibers may have a variety of suitable compositions. For instance, it is possible for a non-woven fiber web to comprise microglass fibers that are high softening point fibers and/or microglass fibers that are not high softening point fibers. Non-limiting examples of staple glass fibers include B glass fibers, E glass fibers, S glass fibers, M glass fibers according to Man Made Vitreous Fibers by Nomenclature Committee of TIMA Inc. March 1993, Page 45, C glass fibers (e.g., Lauscha C glass fibers, JM 253 C glass fibers), and non-persistent glass fibers (e.g., fibers that are configured to dissolve completely in the fluid present in human lungs in less than or equal to 40 days, such as Johns Manville 481 fibers).

As described above, the microglass fibers suitable for inclusion in the non-woven fiber webs described herein are a type of staple glass fiber. Accordingly, they may have average lengths and comprise fibers having a diameter in some or all of the ranges described above with respect to the average lengths of staple glass fibers. Microglass fibers are typically relatively fine, and so may have average diameters in some or all of the ranges described above with respect to the average diameters of staple glass fibers that have an upper limit of less than or equal to 5 microns.

The present disclosure recognizes advantages to including other fibers, in addition to glass fibers, within non-woven fiber webs suitable for use as thermal insulation materials. The additional fibers may provide a number of advantages, including improved processability of a non-woven fiber web and/or improved adhesion between glass fibers in a non-woven fiber web. The inclusion of additional fibers may, for example, improve the tensile strength, elongation at break, and/or one or more other mechanical properties of a non-woven fiber web.

One example of a type of additional fiber is a binder fiber. A variety of suitable types of binder fibers may be employed in the non-woven fiber webs described herein. In some embodiments, the binder fibers comprise multicomponent fibers. The multicomponent fibers may comprise bicomponent fibers (i.e., fibers including two components), and/or may comprise fibers comprising three or more components. Multicomponent fibers may have any of a variety of suitable structures. For instance, a non-woven fiber web may comprise one or more of the following types of multicomponent fibers: core/sheath fibers (e.g., concentric core/sheath fibers, non-concentric core-sheath fibers), segmented pie fibers, side-by-side fibers, tip-trilobal fibers, and “island in the sea” fibers. Core-sheath bicomponent fibers may comprise a sheath that has a lower melting temperature than that of the core. When heated (e.g., during a binding step), the sheath may melt prior to the core, binding the non-woven fiber web together while the core remains solid

Non-limiting examples of suitable materials that may be included in multicomponent binder fibers include poly(olefin)s such as poly(ethylene), poly(propylene), and poly(butylene); poly(ester)s and co-poly(ester)s such as poly(ethylene terephthalate) (e.g., amorphous poly(ethylene terephthalate)), co-poly(ethylene terephthalate), poly(butylene terephthalate), and poly(ethylene isophthalate); poly(amide)s and co-poly(amides) such as nylons and aramids; and halogenated polymers such as poly(tetrafluoroethylene). Suitable co-poly(ethylene terephthalate)s may comprise repeat units formed by the polymerization of ethylene terephthalate monomers and further comprise repeat units formed by the polymerization of one or more comonomers. Such comonomers may include linear, cyclic, and branched aliphatic dicarboxylic acids having 4-12 carbon atoms (e.g., butanedioic acid, pentanedioic acid, hexanedioic acid, dodecanedioic acid, and 1,4-cyclo-hexanedicarboxylic acid); aromatic dicarboxylic acids having 8-12 carbon atoms (e.g., isophthalic acid and 2,6-naphthalenedicarboxylic acid); linear, cyclic, and branched aliphatic diols having 3-8 carbon atoms (e.g., 1,3-propane diol, 1,2-propanediol, 1,4-butanediol, 3-methyl-1,5-pentanediol, 2,2-dimethyl-1,3-propanediol, 2-methyl-1,3-propanediol, and 1,4-cyclohexanediol); and/or aliphatic and aromatic/aliphatic ether glycols having 4-10 carbon atoms (e.g., hydroquinone bis(2-hydroxyethyl) ether and poly(ethylene ether) glycols having a molecular weight below 460 g/mol, such as diethylene ether glycol).

Non-limiting examples of suitable pairs of materials that may be included in bicomponent fibers include poly(ethylene)/poly(ethylene terephthalate), poly(propylene)/poly(ethylene terephthalate), co-poly(ethylene terephthalate)/poly(ethylene terephthalate), poly(butylene terephthalate)/poly(ethylene terephthalate), co-poly(amide)/poly(amide), and poly(ethylene)/poly(propylene). In the preceding list, the material having the lower melting temperature is listed first and the material having the higher melting temperature is listed second. Core-sheath bicomponent fibers comprising one of the above such pairs may have a sheath comprising the first material and a core comprising the second material.

In embodiments in which a non-woven fiber web comprises two or more types of bicomponent fibers, each type of bicomponent fiber may independently comprise one of the pairs of materials described above.

The multicomponent binder fibers described herein may have a variety of suitable melting points and/or comprise components having a variety of suitable melting points. In some embodiments, a non-woven fiber web comprises a multicomponent fiber (e.g., a bicomponent fiber) comprising a component having a melting point of greater than or equal to 80° C., greater than or equal to 90° C., greater than or equal to 100° C., greater than or equal to 110° C., greater than or equal to 120° C., greater than or equal to 130° C., greater than or equal to 140° C., greater than or equal to 150° C., greater than or equal to 160° C., greater than or equal to 170° C., greater than or equal to 180° C., greater than or equal to 190° C., greater than or equal to 200° C., greater than or equal to 210° C., greater than or equal to 220° C., greater than or equal to 230° C., greater than or equal to 240° C., or greater than or equal to 250° C. In some embodiments, a non-woven fiber web comprises a multicomponent fiber (e.g., a bicomponent fiber) comprising a component having a melting point less than or equal to 260° C., less than or equal to 250° C., less than or equal to 240° C., less than or equal to 230° C., less than or equal to 220° C., less than or equal to 210° C., less than or equal to 200° C., less than or equal to 190° C., less than or equal to 180° C., less than or equal to 170° C., less than or equal to 160° C., less than or equal to 150° C., less than or equal to 140° C., less than or equal to 130° C., less than or equal to 120° C., less than or equal to 110° C., less than or equal to 100° C., or less than or equal to 90° C. Combinations of the above-referenced ranges are also possible (e.g., greater than or equal to 80° C. and less than or equal to 260° C., or greater than or equal to 110° C. and less than or equal to 230° C.). Other ranges are also possible.

The melting points of the components of a multicomponent fiber may be determined by performing differential scanning calorimetry. The differential scanning calorimetry measurement may be carried out by heating the multicomponent fiber to 300° C. at 20° C./minute, cooling the multicomponent fiber to room temperature, and then determining the melting point during a reheating to 300° C. at 20° C./minute.

A non-woven fiber web described herein may comprise multicomponent fibers in any of a variety of suitable amounts. In some embodiments, a non-woven fiber web comprises multicomponent fibers (e.g., bicomponent fibers) in an amount of greater than or equal to 4 wt %, greater than or equal to 5 wt %, greater than or equal to 6 wt %, greater than or equal to 7 wt %, greater than or equal to 8 wt %, greater than or equal to 9 wt %, greater than or equal to 10 wt %, greater than or equal to 11 wt %, greater than or equal to 12 wt %, or greater than or equal to 13 wt % versus the total weight of the non-woven fiber web. In some embodiments, a non-woven fiber web comprises multicomponent fibers (e.g., bicomponent fibers) an amount of less than or equal to 20 wt %, less than or equal to 19 wt %, less than or equal to 18 wt %, less than or equal to 17 wt %, less than or equal to 16 wt %, less than or equal to 15 wt %, less than or equal to 14 wt %, less than or equal to 13 wt %, less than or equal to 12 wt %, less than or equal to 11 wt %, or less than or equal to 10 wt versus the total weight of the non-woven fiber web. Combinations of these ranges are also possible (e.g., greater than or equal to 4 wt % and less than or equal to 20 wt %, greater than or equal to 6 wt % and less than or equal to 15 wt %, or greater than or equal to 8 wt % and less than or equal to 12 wt % versus the total weight of the non-woven fiber web). Other ranges are also possible.

A non-woven fiber web described herein may comprise multicomponent fibers having any of a variety of suitable diameters. In some embodiments, a non-woven fiber web comprises multicomponent fibers (e.g., bicomponent fibers) having an average fiber diameter of greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, or greater than or equal to 12 microns. In some embodiments, a non-woven fiber web comprises multicomponent fibers (e.g., bicomponent fibers) having an average fiber diameter of less than or equal to 18 microns, less than or equal to 17 microns, less than or equal to 16 microns, less than or equal to 15 microns, less than or equal to 14 microns, less than or equal to 13 microns, less than or equal to 12 microns, less than or equal to 11 microns, less than or equal to 10 microns, less than or equal to 9 microns, or less than or equal to 8 microns. Combinations of these ranges are also possible (e.g., greater than or equal to 3 microns and less than or equal to 18 microns, greater than or equal to 4 microns and less than or equal to 13 microns, or greater than or equal to 5 microns and less than or equal to 10 microns). Other ranges are also possible.

A non-woven fiber web described herein may comprise multicomponent fibers having any of a variety of suitable lengths. In some embodiments, a non-woven fiber web comprises multicomponent fibers (e.g., bicomponent fibers) having an average length of greater than or equal to 3 mm, greater than or equal to 4 mm, greater than or equal to 5 mm, greater than or equal to 6 mm, greater than or equal to 7 mm, greater than or equal to 8 mm, greater than or equal to 9 mm, or greater than or equal to 10 mm. In some embodiments, a non-woven fiber web comprises multicomponent fibers (e.g., bicomponent fibers) having an average length of less than or equal to 15 mm, less than or equal to 14 mm, less than or equal to 13 mm, less than or equal to 12 mm, less than or equal to 11 mm, less than or equal to 10 mm, less than or equal to 9 mm, less than or equal to 8 mm, less than or equal to 7 mm, or less than or equal to 6 mm. Combinations of these ranges are also possible (e.g., greater than or equal to 3 mm and less than or equal to 18 mm, greater than or equal to 4 mm and less than or equal to 13 mm, or greater than or equal to 5 mm and less than or equal to 10 mm). Other ranges are also possible.

Some non-woven fiber webs described herein comprise a combination of components and/or have an arrangement of components that result in the non-woven fiber web having a relatively low thermal conductivity. Such components may comprise particular fibers, such as those described above. Relevant arrangements of components may be those in which any components that are relatively thermally conductive are minimally connected and/or form relatively few networks that span the thickness of the non-woven fiber web. It is also possible for a non-woven fiber web to comprise a non-fibrous component having a relatively low thermal conductivity and/or that reduces the thermal conductivity of the non-woven fiber web as a whole. Incorporation of a non-fibrous component as an additive may reduce the thermal conductivity of a non-woven web, relative to a non-woven web with otherwise identical components and without the non-fibrous component.

One non-limiting example of such a non-fibrous component is an aerogel. Some aerogels have low thermal conductivities, and their incorporation into a non-woven fiber web may further reduce the thermal conductivity of the non-woven fiber web. An aerogel may be a low-density, porous material. In some embodiments, an aerogel takes the form of a porous solid (e.g., a microporous solid) in which a gas (e.g., air) is disposed in the pores. In some embodiments, aerogels are produced by extraction of a liquid from a gel to produce a solid matrix. This may be accomplished by supercritical drying and/or freeze-drying. During or after liquid extraction, gas may be infiltrated into some or all of the locations at which the liquid was originally present.

Any of a variety of appropriate aerogels may be used. As one example, some aerogels comprise a cross-linked, macromolecular structure. As another example, some aerogels are ceramic. For instance, some aerogels comprise an inorganic oxide. Non-limiting examples of inorganic oxide aerogels are silica (SiO₂) aerogels, silica hybrid aerogels (e.g., a silica hybrid aerogel having the formula (SiO₂)ₓ(RSiO_{1.5})_{y}, where R may be an alkyl group, such as a methyl group, an ethyl group, a propyl group, or a butyl group), titania (TiO₂) aerogels, and alumina (Al₂O₃) aerogels. Without wishing to be bound by any particular theory, it is believed that aerogels having the formula (SiO₂)ₓ(RSiO_{1.5})_{y} may advantageously be relatively hydrophobic and/or resist moisture uptake from air. In some embodiments, an aerogel comprises two or more of the above-described types of aerogels. It should, of course, be understood that these examples are non-limiting and that other aerogels may be used.

A non-woven fiber web described herein may comprise an aerogel in any of a variety of suitable amounts. In some embodiments, a non-woven fiber web comprises an aerogel in an amount of greater than or equal to 0 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, or greater than or equal to 40 wt % versus the total weight of the non-woven fiber web. In some embodiments, a non-woven fiber web comprises an aerogel in an amount of less than or equal to 50 wt %, less than or equal to 45 wt %, less than or equal to 40 wt %, less than or equal to 35 wt %, less than or equal to 30 wt %, or less than or equal to 25 wt % versus the total weight of the non-woven fiber web. Combinations of these ranges are also possible (e.g., greater than or equal to 0 wt % and less than or equal to 50 wt %, greater than or equal to 10 wt % and less than or equal to 50 wt %, greater than or equal to 15 wt % and less than or equal to 40 wt %, or greater than or equal to 20 wt % and less than or equal to 30 wt % versus the total weight of the non-woven fiber web). Other ranges are also possible. In some embodiments, an aerogel makes up 0 wt % of a non-woven fiber web (i.e., the non-woven fiber web does not include an aerogel).

An aerogel used in a non-woven fiber web described herein may have a relatively high stability at high temperatures. For example, a non-woven fiber web described herein may comprise an aerogel having any of a variety of suitable melting temperatures. In some embodiments, a non-woven fiber web comprises an aerogel having a melting temperature of greater than or equal to greater than or equal to 1,000° C., greater than or equal to 1,050° C., greater than or equal to 1,100° C., greater than or equal to 1,150° C., greater than or equal to 1,200° C., or greater than or equal to 1,250° C. In some embodiments, a non-woven fiber web comprises an aerogel having a melting temperature of less than or equal to 2,200° C., less than or equal to 2,100° C., less than or equal to 2,000° C., less than or equal to 1,900° C., less than or equal to 1,800° C., less than or equal to 1,700° C., less than or equal to 1,600° C., less than or equal to 1,500° C., less than or equal to 1,400° C., less than or equal to 1,300° C., or less than or equal to 1,200° C. Combinations of these ranges are also possible (e.g., greater than or equal to 1,000° C. and less than or equal to 2,200° C.). Other ranges are also possible. The melting point of an aerogel may be determined in accordance with ASTM E794-2006.

An aerogel described herein may have a relatively high porosity. In some embodiments, a non-woven fiber web comprises an aerogel having a porosity of greater than or equal to 90%, greater than or equal to 92%, greater than or equal to 95%, greater than or equal to 97%, greater than or equal to 97.5%, greater than or equal to 98%, greater than or equal to 98.5%, greater than or equal to 99%, or greater than or equal to 99.5%. In some embodiments, a non-woven fiber web comprises an aerogel having a porosity of less than 100%, less than or equal to 99.9%, less than or equal to 99.5%, less than or equal to 99%, less than or equal to 98.5%, less than or equal to 98%, less than or equal to 97.5%, less than or equal to 97%, less than or equal to 95%, or less than or equal to 92%. Combinations of these ranges are also possible (e.g., greater than or equal to 90% and less than 100%, or greater than or equal to 97% and less than 100%). Other ranges are also possible. The porosity of an aerogel may be determined in accordance with ASTM D4284-2012.

Some aerogels have a relatively fine average pore diameter. In some embodiments, a non-woven fiber web comprises an aerogel having an average pore diameter of less than or equal to 150 nm, less than or equal to 125 nm, less than or equal to 100 nm, less than or equal to 90 nm, less than or equal to 80 nm, less than or equal to 70 nm, less than or equal to 60 nm, less than or equal to 50 nm, less than or equal to 40 nm, or less than or equal to 30 nm. In some embodiments, a non-woven fiber web comprises an aerogel having an average pore diameter of greater than or equal to 0.5 nm, greater than or equal to 1 nm, greater than or equal to 2 nm, greater than or equal to 3 nm, greater than or equal to 4 nm, greater than or equal to 5 nm, greater than or equal to 8 nm, greater than or equal to 10 nm, greater than or equal to 15 nm, greater than or equal to 20 nm, greater than or equal to 30 nm, greater than or equal to 40 nm, greater than or equal to 50 nm, greater than or equal to 60 nm, greater than or equal to 70 nm, or greater than or equal to 80 nm. Combinations of these ranges are also possible (e.g., greater than or equal to 0.5 nm and less than or equal to 150 nm). Other ranges are also possible. The average pore diameter of an aerogel may be determined in accordance with ASTM D4284-2012

In some embodiments, an aerogel may have a relatively low liquid water uptake. Such aerogels may advantageously retain a relatively low amount of water after being exposed to liquid water. In some embodiments, an aerogel has a liquid water uptake of less than or equal to 100 wt %, less than or equal to 90 wt %, less than or equal to 75 wt %, less than or equal to 50 wt %, less than or equal to 25 wt %, less than or equal to 10 wt %, less than or equal to 5 wt %, less than or equal to 1 wt %, less than or equal to 0.5 wt %, or less than or equal to 0.1 wt %. In some embodiments, an aerogel has a liquid water uptake of greater than or equal to 0 wt %, greater than or equal to 0.1 wt %, greater than or equal to 0.5 wt %, greater than or equal to 1 wt %, greater than or equal to 5 wt %, greater than or equal to 10 wt %, or greater than or equal to 25 wt %. Combinations of these ranges are also possible (e.g., greater than or equal to 0 wt % and less than or equal to 100 wt %). Other ranges are also possible. In some embodiments, the liquid water uptake of an aerogel is 0 wt %. The liquid water uptake of an aerogel exposed to liquid water may be determined by ASTM C1511-15.

In some embodiments, an aerogel may be configured to have a relatively low water vapor uptake. Such aerogels may advantageously retain a relatively low amount of water after being exposed to water vapor. In some embodiments, an aerogel has a water vapor uptake of less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 5 wt %, less than or equal to 1 wt %, less than or equal to 0.5 wt %, or less than or equal to 0.1 wt %. In some embodiments, an aerogel has a water vapor uptake of greater than or equal to 0 wt %, greater than or equal to 0.1 wt %, greater than or equal to 0.5 wt %, greater than or equal to 1 wt %, greater than or equal to 5 wt %, greater than or equal to 10 wt %, or greater than or equal to 25 wt %. Combinations of these ranges are also possible (e.g., greater than or equal to 0 wt % and less than or equal to 50 wt %). Other ranges are also possible. In some embodiments, the water vapor uptake of an aerogel is 0 wt %. The water vapor uptake of an aerogel may be determined by ASTM C1104-13A.

In some embodiments, non-woven fiber webs described herein may be capable of and/or configured to slow and/or prevent the spread of fire between electrochemical cells. This may be facilitated by the inclusion of one or more fire retardants. When present, a fire retardant may be capable of and/or configured to undergo a chemical reaction upon exposure to a high temperature. This chemical reaction may be suitable for slowing and/or preventing the spread of a fire. Some fire retardants may be capable of and/or configured to release water and/or carbon dioxide upon exposure to a high temperature. For example, a fire retardant may be capable of and/or configured to release these compounds upon undergoing thermal decomposition caused by exposure to the high temperature. In some embodiments, a fire retardant undergoes an endothermic reaction upon exposure to a high temperature. The endothermic reaction may consume heat and/or slowing the spread of fire and/or heat within a battery.

Any of a variety of fire retardants may be used within a non-woven fiber webs described herein. For example, a fire retardant may be or comprise a hydroxide (e.g., boron hydroxide, aluminum hydroxide, aluminum oxyhydroxide (AlOOH), calcium hydroxide, magnesium hydroxide), carbonate (e.g., calcium carbonate, magnesium carbonate), a mineral material which can release water and/or carbon dioxide upon heating (e.g., vermiculite, kaolin, hydromagnesite, huntite, and/or dolomite), an organic halide (e.g., a chloride, a bromide), and/or a phosphor-containing species (e.g., disodium hydrogen phosphate, lithium iron phosphate, magnesium phosphate, sodium phosphate, diammonium phosphate, and/or phosphoric acid antimony). Of course, a fire retardant is not limited to these classes of compounds and other suitable fire retardants may be used.

A fire retardant may be incorporated into a non-woven fiber web in any of a variety of suitable forms. For example, in some embodiments, a fire retardant is incorporated as a particulate that is dispersed among the fibers of a non-woven fiber web.

A non-woven fiber web described herein may comprise a fire retardant in any of a variety of suitable amounts. In some embodiments, a non-woven fiber web comprises a fire retardant in an amount of greater than or equal to 0 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, or greater than or equal to 45 wt %. In some embodiments, a non-woven fiber web comprises a fire retardant in an amount of less than or equal to 50 wt %, less than or equal to 45 wt %, less than or equal to 40 wt %, less than or equal to 35 wt %, or less than or equal to 30 wt % versus the total weight of the non-woven fiber web. Combinations of these ranges are also possible (e.g., greater than or equal to 0 wt % and less than or equal to 70 wt %, greater than or equal to 20 wt % and less than or equal to 50 wt %, greater than or equal to 15 wt % and less than or equal to 40 wt %, or greater than or equal to 20 wt % and less than or equal to 30 wt % versus the total weight of the non-woven fiber web). Other ranges are also possible. In some embodiments, a fire retardant makes up 0 wt % of a non-woven fiber web (i.e., the non-woven fiber web does not include a fire retardant).

A fire retardant described herein may comprise particles having any of a variety of average diameters. In some embodiments, the fire retardant comprises particles having an average diameter of greater than or equal to 0.5 microns, greater than or equal to 0.6 microns, greater than or equal to 0.7 microns, greater than or equal to 0.8 microns, greater than or equal to 0.9 microns, greater than or equal to 1 micron, greater than or equal to 2 microns, greater than or equal to 5 microns, greater than or equal to 10 microns, greater than or equal to 15 microns, greater than or equal to 20 microns, greater than or equal to 25 microns, greater than or equal to 30 microns, greater than or equal to microns, greater than or equal to 40 microns, greater than or equal to 45 microns, or greater than or equal to 50 microns. In some embodiments, the fire retardant comprises particles having an average diameter of less than or equal to 100 microns, less than or equal to 95 microns, less than or equal to 90 microns, less than or equal to 85 microns, less than or equal to 80 microns, less than or equal to 75 microns, less than or equal to 70 microns, less than or equal to 65 microns, less than or equal to 60 microns, less than or equal to 55 microns, less than or equal to 50 microns, less than or equal to 45 microns, or less than or equal to 40 microns. Combinations of these ranges are also possible (e.g., greater than or equal to 0.5 microns and less than or equal to 100 microns, greater than or equal to 1 micron and less than or equal to 95 microns, or greater than or equal to 5 microns and less than or equal to 80 microns). Other ranges are also possible. The average diameter of the particles may be determined in accordance with IS013320-2020.

In some embodiments, a non-woven fiber web is hydrophobic and/or comprises a hydrophobic component. Non-limiting examples of hydrophobic components include hydrophobic aerogels (as described elsewhere herein) and hydrophobic additives. Further examples of hydrophobic components are described below.

When present, hydrophobic additives may make up a relatively small amount of the non-woven fiber webs described herein. In some embodiments, a hydrophobic additive makes up less than or equal to 3 wt %, less than or equal to 2 wt %, less than or equal to 1 wt %, less than or equal to 0.75 wt %, less than or equal to 0.5 wt %, less than or equal to 0.2 wt %, or less than or equal to 0.1 wt % of a non-woven fiber web. In some embodiments, a hydrophobic additive makes up greater than or equal to 0 wt %, greater than or equal to 0.1 wt %, greater than or equal to 0.2 wt %, greater than or equal to 0.5 wt %, greater than or equal to 0.75 wt %, greater than or equal to 1 wt %, or greater than or equal to 2 wt % of a non-woven fiber web. Combinations of these ranges are also possible (e.g., less than or equal to 3 wt % and greater than or equal to 0 wt %). Other ranges are also possible. In some embodiments, a hydrophobic component makes up 0 wt % of a non-woven fiber web (i.e., the non-woven fiber web does not include a hydrophobic component).

In some embodiments, a non-woven fiber web comprises a hydrophobic additive that is a silane, a siloxane, and/or a silicone. Non-limiting examples of such additives include alkylsilanes, fluoroalkylsilanes, and silicones. Non-limiting examples of suitable alkylsilanes include n-octadecyl trihydroxysilane, n-octadecyl trichlorosilane, and isobutyltrimethoxysilane. Non-limiting examples of suitable fluoroalkylsilanes include (tridecafluoro-1,1,2,2-tetrahydrooctyl)trichlorosilane, (3,3,3-trifluoropropyl)trichlorosilane, and (heptadecafluoro-1,1,2,2-tetrahydrodecyl)trichlorosilane. Non-limiting examples of suitable silicones include methylhydrosiloxane-dimethylsiloxane copolymers and poly(dimethylsiloxane).

In some embodiments, a non-woven fiber web comprises a hydrophobic additive that is fluorinated. A fluorinated hydrophobic additive may be in polymeric or non-polymeric form. For fluorinated polymeric additives, the repeat units of may include at least one fluorine atom. Such polymers may be linear, branched, cyclic, saturated, and/or unsaturated.

In some cases, a non-woven fiber web comprises a hydrophobic additive that is highly fluorinated. For instance, at least 30%, at least 50%, at least 70%, or at least 90% of the hydrogen atoms of the hydrophobic additive may be replaced by fluorine atoms. Fluorinated hydrophobic additives may comprise a fluorine to hydrogen ratio of, for example, at least 0.2:1, at least 0.5:1, at least 1:1, at least 2:1, at least 5:1, or at least 10:1. In some such embodiments, at least 30%, at least 50%, at least 70%, or at least 90% but less than 100% of the hydrogen atoms of the fluorinated hydrophobic additive are replaced by fluorine atoms. In some embodiments, a hydrophobic additive is perfluorinated. Such hydrophobic additives may contain fluorine atoms but not hydrogen atoms.

In some embodiments, a hydrophobic additive that is fluorinated comprises two oligomeric (or polymeric) components including a fluorophilic component (e.g., component “A”) and a hydrocarbon component (e.g., component “B”). These components may form a diblock-copolymer (e.g., an “A-B” structure) or other suitable structure. For example, a fluorophilic component may be one described herein, and the hydrocarbon component may include, for instance, an alkyl-containing or aromatic-containing component (including acrylate- or urethane-based components).

In some embodiments, the fluorophilic component of a fluorinated hydrophobic additive, or a fluorinated hydrophobic additive itself, is a fluorinated oligomer or polymer. The fluorinated polymer may be a fluorocarbon polymer. In some embodiments, the fluorophilic component of a fluorinated species includes one or more fluorinated polymers, where the number of monomer units forming the fluorinated polymer is less than or equal to 10, less than or equal to 8, less than or equal to 6, less than or equal to 4, or less than or equal to 2. In certain embodiments, the fluorophilic component is a component where at least 30%, at least 50%, at least 70%, or at least 90% of the hydrogen atoms of the fluorophilic component are replaced by fluorine atoms. The fluorophilic component may comprise a fluorine to hydrogen ratio of, for example, at least 0.2:1, at least 0.5:1, at least 1:1, at least 2:1, at least 5:1, or at least 10:1. In some cases, the fluorophilic component is perfluorinated.

Non-limiting examples of types of fluorinated polymers or oligomers that can be included in a fluorinated hydrophilic additive (e.g., in a fluorophilic chain and/or as side chains), include vinylidene fluoride (VDF), (per)fluoroolefins (e.g., tetrafluoroethylene (TFE)), chlorotrifluoroethylene (CTFE), (per)fluoroalkylvinylethers (PAVE), e.g., CF₂═CFOR_{f}, where R_{f} is a (per)fluoroether or a C. (per)fluoroalkyl such as trifluoromethyl or pentafluoropropyl, where n is an integer; and perfluoro-oxyalkylvinylethers CF₂═CFORₓ, where x is a C1-C12 perfluoro-oxyalkyl having one or more ether groups, for example, perfluoro-2-propoxy-propyl. Other examples of monomers present within the fluorinated species include fluorinated acrylates and fluorinated methacrylates.

In some embodiments, a fluorinated polymer may include a (per)fluoropolyether chain. The (per)fluoropolyether chain may comprise repeating units including, but not limited to, —(CₙF₂ₙO)ₓ—, where n is an integer, for example, —(C₃F₆O)ₓ—, —(C₄F₈O)ₓ—, —(C₅F₁₀O)ₓ—; —(CF(CF₃)CF₂O)ₓ—; —(CF₂CF₂O)ₓ—; —(CF(CF₃)CF₂O)ₓ—CF(CF₃)CONH—; —(CF₂(CF₂)ₓF₂O)ₓ—, where z′ is an integer; —(CFLO)ₓ—, where L=—F or —CF₃; and —(CH₂CF₂CF₂O)ₓ—. In some cases, (CₙF₂ₙ₊₁O)ₓ—, where n is an integer (for example, —(CF₃O)ₓ—, —(C₂F₅O)ₓ—, —(C₃F₇O)ₓ—, etc.), is used as a terminal group and may not be polymerizable. In some cases, a (per)fluoropolyether chain may have the structure (CₙFₘO)ₓ—, where n and m are integers properly chosen to form a valid structure. In some embodiments, a fluorinated polymer comprises poly((per)fluoromethylene oxide), poly((per)fluoroethylene oxide), poly((per)fluoropropylene oxide), and/or poly((per)fluorobutylene oxide). In some embodiments, x in the structures above is less than or equal to 10. For example, x may be equal to 8, 6, 4, or 2.

In some embodiments, a non-woven fiber web comprises a hydrophobic additive that is a fluorocarbon polymer (also known as a fluorocarbon). In one embodiment, the fluorocarbon polymer used is a fluoroacrylate copolymer emulsion that includes a dipropylene glycol monomethyl ether. An example of a suitable fluorocarbon is the Asahi Guard AG 955 (product code #930078) from LJ Specialties Limited (Enterprise Drive, Holmewood Industrial Park, Holmewood, Chesterfield, Derbyshire, S42 5UW United Kingdom). Another example of a suitable fluorocarbon is a Repearl F-35 Fluorochemical from MIC Specialty Chemicals, Inc. (134 Mill Street, Tiverton, RI 02878). A further example of a suitable fluorocarbon is a Phobol 8195 from Huntsman International, Textile Effects (4050 Premier Drive, High Point, NC 27265).

In some embodiments, a non-woven fiber web comprises a hydrophobic additive that includes a chain comprising the formula —CₙFₘR_{y}, where n is an integer greater than 1, m is an integer greater than 1, R is zero, an atom or a group of atoms (e.g., hydrogen, oxygen, sulfur, nitrogen, carbon or an endgroup described herein), and y is an integer greater than or equal to 0. In some embodiments, n is an integer less than or equal to 8, and m is an integer greater than 1 (e.g., —C₈F₁₅H₂, —C₈F₁₆H₁, —C₈F₁₇). In some embodiments, n is an integer less than or equal to 6, and m is an integer greater than 1. For example, in one particular embodiment, a chain comprises the formula —C₆F₁₂H₁. In another example, a chain comprises the formula —C₆F₁₃. In some embodiments, n is an integer less than or equal to 4, and m is an integer greater than 1 (e.g., —C₄F₇H₂, —C₄F₈H₁, —C₄F₉). The chain may include, in some embodiments, the formula —CₙF₂ₙ₊₁. In some embodiments, n is an integer greater than or equal to 6, and m is an integer greater than 1. Such chains comprising the formula —CₙFₘR_{y} may be part of, for example, a fluoroacrylate polymer or other suitable polymer.

Further examples of hydrophobic additives include poly(olefins) (e.g., poly(propylene)), waxes, paraffins, rosin, stearic acid-melamine water repellents, stearates, water repellents comprising an aldehyde, sizing agents, and alkylketene dimers.

In some embodiments, a hydrophobic additive and/or a non-woven fiber web (e.g., comprising a hydrophobic additive) has a relatively high water contact angle. In some embodiments, a hydrophobic additive and/or a non-woven fiber web has a water contact angle of greater than or equal to 90°, greater than or equal to 100°, greater than or equal to 110°, greater than or equal to 120°, greater than or equal to 130°, greater than or equal to 140°, or greater than or equal to 150°. In some embodiments a hydrophobic additive and/or a non-woven fiber web has a water contact angle of less than or equal to 180°, less than or equal to 170°, less than or equal to 160°, less than or equal to 150°, less than or equal to 140°, less than or equal to 130°, less than or equal to 120°, less than or equal to 110°, or less than or equal to 100°. Combinations of these ranges are also possible (e.g., greater than or equal to 90° and less than or equal to 180°). Other ranges are also possible. The water contact angle may be measured using standard ASTM D5946 (2009). The water contact angle is the angle between the surface of the hydrophobic additive and the tangent line drawn to the water droplet surface at the three-phase point (solid, liquid, and gas phase point) when a liquid drop is resting on the substrate surface. A contact angle meter or goniometer can be used for this determination.

In some embodiments, a non-woven fiber web is resistant to shrinkage at elevated temperatures. Resistance to shrinkage at elevated temperatures may be advantageous for non-woven fiber webs used as thermal insulation materials because shrinkage of a non-woven fiber web may reduce its ability to inhibit heat flow between electrochemical cells, or may otherwise interfere with a fire retardant and/or insulating properties of a non-woven fiber web. The shrinkage of a non-woven fiber web at a particular temperature may be determined by the following procedure. First, the initial length of the non-woven fiber web in the relevant direction may be measured. Next, the non-woven fiber web may be placed in an oven set and equilibrated at the relevant temperature. The interior of the oven may contain air that is in fluid communication with room temperature ambient air external to the exterior of the oven. The humidity of the ambient air external to the oven may be 45%. The non-woven fiber web may be retained in this oven for 10 minutes and then removed and allowed to cool to room temperature in room temperature air. Then, a final length of the non-woven fiber web in the relevant direction may be measured. The shrinkage in the relevant direction can be determined by applying the following formula, using lengths taken in a consistent direction: shrinkage=[(initial length of the non-woven fiber web−final length of the non-woven fiber web)/initial length of the non-woven fiber web]. The relevant direction may be a machine direction (MD) or a cross direction (CD), although shrinkage may also be measured in other directions.

In some embodiments, a non-woven fiber web experiences a shrinkage of less than or equal to 15%, less than or equal to 14%, less than or equal to 13%, less than or equal to 12%, less than or equal to 11%, less than or equal to 10%, less than or equal to 9%, less than or equal to 8%, less than or equal to 7%, less than or equal to 6%, less than or equal to 5%, or less than or equal to 4% when retained in an 800° C. oven for 10 minutes. In some embodiments, a non-woven fiber web experiences a shrinkage of greater than or equal to 0%, greater than or equal to 0.5%, greater than or equal to 1%, greater than or equal to 1.5%, greater than or equal to 2%, greater than or equal to 2.5%, greater than or equal to 3%, greater than or equal to 4%, greater than or equal to 5%, greater than or equal to 6%, greater than or equal to 7%, greater than or equal to 8%, or greater than or equal to 9% when retained in an 800° C. oven for 10 minutes. Combinations of these ranges are also possible (e.g., greater than or equal to 0% and less than or equal to 15%, greater than or equal to 0% and less than or equal to 10%, greater than or equal to 0.5% and less than or equal to 10%, greater than or equal to 0% and less than or equal to 2.5%, or greater than or equal to 0% and less than or equal to 10%). Other ranges are also possible.

In some embodiments, a non-woven fiber web has a shrinkage in the machine direction in one or more of the above-referenced ranges when retained in an 800° C. oven for 10 minutes. In some embodiments, a non-woven fiber web has a shrinkage in the cross direction in one or more of the above-referenced ranges when retained in an 800° C. oven for 10 minutes.

A non-woven fiber web has a low thermal conductivity, in some embodiments. In some embodiments, a non-woven fiber web has a thermal conductivity of less than or equal to 70 mW/m-K, less than or equal to 65 mW/m-K, less than or equal to 62 mW/m-K, less than or equal to 60 mW/m-K, less than or equal to 58 mW/m-K, less than or equal to 55 mW/m-K, less than or equal to 55 mW/m-K, less than or equal to 52 mW/m-K, less than or equal to 50 mW/m-K, less than or equal to 48 mW/m-K, less than or equal to 45 mW/m-K, less than or equal to 42 mW/m-K, less than or equal to 40 mW/m-K, less than or equal to 38 mW/m-K, or less than or equal to 35 mW/m-K. In some embodiments, a non-woven fiber web has a thermal conductivity of greater than or equal to 15 mW/m-K, greater than or equal to 18 mW/m-K, greater than or equal to 20 mW/m-K, greater than or equal to 22 mW/m-K, greater than or equal to 25 mW/m-K, greater than or equal to 28 mW/m-K, greater than or equal to 30 mW/m-K, greater than or equal to 32 mW/m-K, greater than or equal to 35 mW/m-K, greater than or equal to 38 mW/m-K, greater than or equal to 40 mW/m-K, or greater than or equal to 45 mW/m-K. Combinations of these ranges are also possible (e.g., greater than or equal to 15 mW/m-K and less than or equal to 70 mW/m-K, greater than or equal to 15 mW/m-K and less than or equal to 65 mW/m-K, greater than or equal to 15 mW/m-K and less than or equal to 55 mW/m-K, or greater than or equal to 15 mW/m-K and less than or equal to 45 mW/m-K). The thermal conductivity of a non-woven fiber web may be determined in accordance with ASTM C518-21. Other ranges are also possible.

In some embodiments, a non-woven fiber web has a thickness of less than or equal to 3.5 mm, less than or equal to 3.25 mm, less than or equal to 3 mm, less than or equal to 2.75 mm, less than or equal to 2.5 mm, less than or equal to 2.25 mm, less than or equal to 2 mm, less than or equal to 1.25 mm, less than or equal to 1.5 mm, or less than or equal to 1.25 mm. In some embodiments, a non-woven fiber web has a thickness of greater than or equal to 0.5 mm, greater than or equal to 0.75 mm, greater than or equal to 1 mm, greater than or equal to 1.25 mm, greater than or equal to 1.5 mm, greater than or equal to 1.75 mm, or greater than or equal to 2 mm. Combinations of these ranges are also possible (e.g., greater than or equal to 0.5 mm and less than or equal to 3.5 mm, greater than or equal to 0.75 and less than or equal to 2.5 mm, or greater than or equal to 1 mm and less than or equal to 2 mm). Other ranges are also possible. The thickness of a non-woven fiber web may be determined in accordance with EN823 (2013) under 1.4 kPa of applied pressure.

A non-woven fiber web described herein may have a variety of suitable basis weights. In some embodiments, a non-woven fiber web has a basis weight of less than or equal to 400 g/m², less than or equal to 375 g/m², less than or equal to 350 g/m², less than or equal to 325 g/m², less than or equal to 300 g/m², less than or equal to 280 g/m², less than or equal to 260 g/m², less than or equal to 240 g/m², less than or equal to 220 g/m², less than or equal to 200 g/m², less than or equal to 180 g/m², less than or equal to 160 g/m², less than or equal to 140 g/m², or less than or equal to 120 g/m². In some embodiments, a non-woven fiber web has a basis weight of greater than or equal to 50 g/m², greater than or equal to 60 g/m², greater than or equal to 70 g/m², greater than or equal to 80 g/m², greater than or equal to 90 g/m², greater than or equal to 100 g/m², greater than or equal to 120 g/m², greater than or equal to 140 g/m², greater than or equal to 160 g/m², greater than or equal to 180 g/m², greater than or equal to 200 g/m², greater than or equal to 220 g/m², greater than or equal to 240 g/m², greater than or equal to 260 g/m², greater than or equal to 280 g/m², greater than or equal to 300 g/m², or greater than or equal to 320 g/m². Combinations of these ranges are also possible (e.g., greater than or equal to 50 g/m² and less than or equal to 400 g/m², greater than or equal to 60 g/m² and less than or equal to 350 g/m², or greater than or equal to 70 g/m² and less than or equal to 280 g/m²). Other ranges are also possible. The basis weight of a non-woven fiber web may be determined in accordance with ISO 536:2012.

A non-woven fiber web may have any of a variety of suitable porosities. The porosity of a non-woven fiber web is equivalent to 100%−[solidity of the non-woven fiber web]. The solidity of a non-woven fiber web is equivalent to the percentage of the interior of the non-woven fiber web occupied by solid material. One non-limiting way of determining solidity of a non-woven fiber web is described in this paragraph, but other methods are also possible. The method described in this paragraph includes determining the basis weight and thickness of the non-woven fiber web and then applying the following formula: solidity=[basis weight of the non-woven fiber web/(density of the components forming the non-woven fiber web thickness of the non-woven fiber web)] 100%. The density of the components forming the non-woven fiber web is equivalent to the average density of the material or material(s) forming the components of the non-woven fiber web (e.g., fibers, particles, aerogels), which is typically specified by the manufacturer of each material. The average density of the materials forming the components of the non-woven fiber web may be determined by: (1) determining the total volume of all of the components in the non-woven fiber web; and (2) dividing the total mass of all of the components in the non-woven fiber web by the total volume of all of the components in the non-woven fiber web. If the mass and density of each component of the non-woven fiber web are known, the volume of all the components in the non-woven fiber web may be determined by: (1) for each type of component, dividing the total mass of the component in the non-woven fiber web by the density of the component; and (2) summing the volumes of each component. If the mass and density of each component of the non-woven fiber web are not known, the volume of all the components in the non-woven fiber web may be determined in accordance with Archimedes' principle.

In some embodiments, a non-woven fiber web has a porosity of greater than or equal to 88%, greater than or equal to 89%, greater than or equal to 90%, greater than or equal to 91%, greater than or equal to 92%, greater than or equal to 93%, greater than or equal to 94%, or greater than or equal to 95%. In some embodiments, a non-woven fiber web has a porosity of less than or equal to 97%, less than or equal to 96%, less than or equal to 95%, less than or equal to 94%, less than or equal to 93%, less than or equal to 92%, or less than or equal to 91%. Combinations of these ranges are also possible (e.g., greater than or equal to 88% and less than or equal to 97%, greater than or equal to 90% and less than or equal to 97%, or greater than or equal to 92% and less than or equal to 97%). Other ranges are also possible.

A non-woven fiber web described herein may have a variety of suitable values of tensile strength. In some embodiments, a non-woven fiber web has a tensile strength in the machine direction of greater than or equal to 0.5 lb/inch, greater than or equal to 0.8 lb/inch, greater than or equal to 1 lb/inch, greater than or equal to 1.2 lb/inch greater than or equal to 1.5 lb/inch, greater than or equal to 1.8 lb/inch, greater than or equal to 2 lb/inch, greater than or equal to 2.2 lb/inch, greater than or equal to 2.5 lb/inch, greater than or equal to 2.8 lb/inch, or greater than or equal to 3 lb/inch. In some embodiments, a non-woven fiber web has a tensile strength in the machine direction of less than or equal to 6 lb/inch, less than or equal to 5.8 lb/inch, less than or equal to 5.5 lb/inch, less than or equal to 5.2 lb/inch, less than or equal to 5 lb/inch, less than or equal to 4.8 lb/inch, less than or equal to 4.5 lb/inch, less than or equal to 4.2 lb/inch, less than or equal to 4 lb/inch, less than or equal to 3.8 lb/inch, or less than or equal to 3.5 lb/inch. Combinations of these ranges are also possible (e.g., greater than or equal to 0.5 lb/inch and less than or equal to 6 lb/inch, greater than or equal to 1 lb/inch and less than or equal to 5 lb/inch, or greater than or equal to 1.5 lb/inch and less than or equal to 4 lb/inch). Other ranges are also possible. The tensile strength in the machine direction of a non-woven fiber web may be determined in accordance with ASTM D5034-21.

In some embodiments, a non-woven fiber web has a tensile strength in the cross direction of greater than or equal to 0.5 lb/inch, greater than or equal to 0.8 lb/inch, greater than or equal to 1 lb/inch, greater than or equal to 1.2 lb/inch greater than or equal to 1.5 lb/inch, greater than or equal to 1.8 lb/inch, greater than or equal to 2 lb/inch, greater than or equal to 2.2 lb/inch, greater than or equal to 2.5 lb/inch, greater than or equal to 2.8 lb/inch, or greater than or equal to 3 lb/inch. In some embodiments, a non-woven fiber web has a tensile strength in the cross direction of less than or equal to 4 lb/inch, less than or equal to 3.8 lb/inch, or less than or equal to 3.5 lb/inch, less than or equal to 3.2 lb/inch, less than or equal to 3 lb/inch, less than or equal to 2.8 lb/inch, less than or equal to 2.5 lb/inch, less than or equal to 2.2 lb/inch, or less than or equal to 2 lb/inch. Combinations of these ranges are also possible (e.g., greater than or equal to 0.5 lb/inch and less than or equal to 4 lb/inch, greater than or equal to 0.8 lb/inch and less than or equal to 3 lb/inch, or greater than or equal to 1 lb/inch and less than or equal to 2 lb/inch). Other ranges are also possible. The tensile strength in the cross direction of a non-woven fiber web may be determined in accordance with ASTM D5034-21.

A non-woven fiber web described herein may have a variety of suitable values of elongation at break. In some embodiments, a non-woven fiber web has a machine direction elongation at break of greater than or equal to 1%, greater than or equal to 1.2%, greater than or equal to 1.4%, greater than or equal to 1.6%, greater than or equal to 1.8%, greater than or equal to 2%, greater than or equal to 2.2%, greater than or equal to 2.4%, greater than or equal to 2.6%, greater than or equal to 2.8%, greater than or equal to 3%, greater than or equal to 3.2%, greater than or equal to 3.4%, greater than or equal to 3.6%, greater than or equal to 3.8%, greater than or equal to 4%, or greater than or equal to 4.2%. In some embodiments, a non-woven fiber web has a machine direction elongation at break of less than or equal to 6%, less than or equal to 5.8%, less than or equal to 5.6%, less than or equal to 5.4%, less than or equal to 5.2%, less than or equal to 5%, less than or equal to 4.8%, less than or equal to 4.6%, less than or equal to 4.4%, less than or equal to 4.2%, less than or equal to 4%, less than or equal to 3.8%, less than or equal to 3.6%, less than or equal to 3.4%, less than or equal to 3.2%, or less than or equal to 3%. Combinations of these ranges are also possible (e.g., greater than or equal to 1% and less than or equal to 6%, greater than or equal to 2% and less than or equal to 5%, or greater than or equal to 3% and less than or equal to 4%). Other ranges are also possible. The machine direction elongation at break of a non-woven fiber web may be determined in accordance with ASTM D5034-21.

In some embodiments, a non-woven fiber web has a cross direction elongation at break of greater than or equal to 2%, greater than or equal to 2.2%, greater than or equal to 2.4%, greater than or equal to 2.6%, greater than or equal to 2.8%, greater than or equal to 3%, greater than or equal to 3.2%, greater than or equal to 3.4%, greater than or equal to 3.6%, greater than or equal to 3.8%, greater than or equal to 4%, greater than or equal to 4.2%, greater than or equal to 4.4%, greater than or equal to 4.6%, greater than or equal to 4.8%, greater than or equal to 5%, greater than or equal to 5.2%, or greater than or equal to 5.4%. In some embodiments, a non-woven fiber web has a cross direction elongation at break of less than or equal to 9%, less than or equal to 8.8%, less than or equal to 8.6%, less than or equal to 8.4%, less than or equal to 8.2%, less than or equal to 8%, less than or equal to 7.8%, less than or equal to 7.6%, less than or equal to 7.4%, less than or equal to 7.2%, less than or equal to 7%, less than or equal to 6.8%, less than or equal to 6.6%, less than or equal to 6.4%, less than or equal to 6.2%, less than or equal to 6%, less than or equal to 5.8%, less than or equal to 5.6%, less than or equal to 5.4%, less than or equal to 5.2%, or less than or equal to 5%. Combinations of these ranges are also possible (e.g., greater than or equal to 2% and less than or equal to 9%, greater than or equal to 3% and less than or equal to 8%, or greater than or equal to 4% and less than or equal to 7%). Other ranges are also possible. The cross-direction elongation at break of a non-woven fiber web may be determined in accordance with ASTM D5034-21.

In some embodiments, a phase that is a non-woven fiber web is fabricated by a wet laying process. In general, a wet laying process involves mixing together fibers of one or more type; for example, a plurality of glass fibers may be mixed together on its own or with a plurality of synthetic fibers to provide a fiber slurry. The slurry may be, for example, an aqueous-based slurry. In some embodiments, fibers are optionally stored separately, or in combination, in various holding tanks prior to being mixed together.

In some embodiments, each plurality of fibers may be mixed and pulped together in separate containers. As an example, a plurality of glass fibers may be mixed and pulped together in one container and a plurality of synthetic fibers (e.g., multicomponent fibers) may be mixed and pulped in a second container. The pluralities of fibers may subsequently be combined together into a single fibrous mixture. Appropriate fibers may be processed through a pulper before and/or after being mixed together. In some embodiments, combinations of fibers are processed through a pulper and/or a holding tank prior to being mixed together. It can be appreciated that other components may also be introduced into the mixture (e.g., additives). Furthermore, it should be appreciated that other combinations of fiber types may be used in fiber mixtures, such as the fiber types described herein.

A wet laying process may comprise applying a single dispersion (e.g., a pulp) in a solvent (e.g., an aqueous solvent such as water) or slurry onto a wire conveyor in a papermaking machine (e.g., a fourdrinier or a rotoformer) to form a single non-woven fiber web supported by the wire conveyor. Vacuum may be continuously applied to the dispersion of fibers during the above process to remove the solvent from the fibers, thereby resulting in an article containing the single non-woven fiber web. In some embodiments, a polymer resin may be applied onto the article to impart advantageous properties (e.g., enhanced mechanical strength, etc.) to the article.

Any suitable method for creating a fiber slurry may be used. In some embodiments, further additives are added to the slurry to facilitate processing. The temperature may also be adjusted to a suitable range, for example, between 33° F. and 100° F. (e.g., between 50° F. and 85° F.). In some cases, the temperature of the slurry is maintained. In some instances, the temperature is not actively adjusted.

In some embodiments, a wet laying process uses similar equipment as in a conventional papermaking process, for example, a hydropulper, a former or a headbox, a dryer, and/or an optional converter. A non-woven fiber web can also be made with a laboratory handsheet mold in some instances. As discussed above, the slurry may be prepared in one or more pulpers. After appropriately mixing the slurry in a pulper, the slurry may be pumped into a headbox where the slurry may or may not be combined with other slurries. Other additives may or may not be added. The slurry may also be diluted with additional water such that the final concentration of the fibers is in a suitable range, such as for example, between about 0.1% and 0.5% by weight.

In some cases, the pH of the slurry may be adjusted as desired. For instance, fibers of the slurry may be dispersed under acidic or neutral conditions.

Before the slurry is sent to a headbox, the slurry may optionally be passed through centrifugal cleaners and/or pressure screens for removing undesired material (e.g., unfiberized material). The slurry may or may not be passed through additional equipment such as refiners or deflakers to further enhance the dispersion of the fibers. For example, deflakers may be useful to smooth out or remove lumps or protrusions that may arise at any point during formation of the fiber slurry. Fibers may then be collected on to a screen or wire at an appropriate rate using any suitable equipment, e.g., a fourdrinier, a rotoformer, or an inclined wire fourdrinier.

As described above, in some embodiments, a non-woven fiber web further comprises an aerogel, a fire retardant, and/or a hydrophobic additive. Such species may be incorporated into a non-woven fiber web during a process by which the non-woven fiber web is formed (e.g., a wet laying process) and/or may be added to the non-woven fiber web after formation (e.g., after a wet laying process). When the former technique is employed, the aerogel, fire retardant, and/or hydrophobic additive (and/or a precursor thereto) may be incorporated into the mixture being wet laid as an additive (e.g., a particulate additive, a non-particulate additive). For example, a particulate aerogel, fire retardant, and/or hydrophobic additive may be incorporated into the mixture being wet laid as an additive. When the latter technique is employed the aerogel, fire retardant, and/or hydrophobic additive (and/or a precursor thereto) may be infiltrated into a non-woven fiber web (e.g., in particulate form, in non-particulate form). In some embodiments, a precursor to an aerogel, a fire retardant, and/or a hydrophobic additive reacts in the non-woven fiber web (and/or mixture being wet laid) to form the aerogel and/or fire retardant after incorporation thereinto.

As described above, in some embodiments, an already-formed non-woven fiber web may be impregnated with an aerogel precursor. A non-limiting method of impregnating the non-woven fiber web with the aerogel may comprise a first step, wherein reagents are mixed to form an aerogel precursor, which is impregnated into a non-woven fiber web. The non-woven fiber web may then be chemically aged in aging fluid, which may be or comprise a same solvent as the aerogel precursor (e.g., the aging fluid may be ethanol). During chemical aging, the aerogel precursor may undergo cross-linking to form a gel. The solvent and the aging fluid (if different) may then be removed from the non-woven fiber web using a supercritical fluid, such as supercritical CO₂. Once the solvent (and, in some instances, the aging fluid) has been removed, the non-woven fiber web may be heat dried (e.g., heat-dried in air), leaving an aerogel within the non-woven fiber web.

A non-woven fiber web impregnated with an aerogel precursor may be aged in an aging fluid for any of a variety of suitable time periods. In some embodiments, a non-woven fiber web impregnated with an aerogel precursor is aged in an aging fluid for a period of greater than or equal to 6 hours, greater than or equal to 8 hours, greater than or equal to 10 hours, greater than or equal to 12 hours, greater than or equal to 14 hours, greater than or equal to 6 hours, greater than or equal to 6 hours, or greater than or equal to 16 hours. In some embodiments, a non-woven fiber web impregnated with an aerogel precursor is aged in an aging fluid for a period of less than or equal to 48 hours, less than or equal to 44 hours, less than or equal to 40 hours, less than or equal to 36 hours, less than or equal to 32 hours, less than or equal to 30 hours, less than or equal to 28 hours, less than or equal to 26 hours, less than or equal to 24 hours, less than or equal to 22 hours, less than or equal to 20 hours, less than or equal to 18 hours, less than or equal to 16 hours, less than or equal to 14 hours, less than or equal to 12 hours, or less than or equal to 10 hours. Combinations of these ranges are also possible (e.g., greater than or equal to 6 hours and less than or equal to 48 hours). Other ranges are also possible.

Any of a variety of volume ratios of aging fluid to aerogel precursor may be used during aging. In some embodiments, a volume ratio of aging fluid to aerogel precursor is greater than or equal to 1:1 greater than or equal to 2:1 greater than or equal to 3:1 greater than or equal to 4:1, greater than or equal to 5:1, or greater than or equal to 6:1. In some embodiments, a volume ratio of aging fluid to aerogel precursor is less than or equal to 20:1, less than or equal to 15:1, less than or equal to 10:1, or less than or equal to 5:1. Combinations of these ranges are also possible (e.g., greater than or equal to 1:1 and less than or equal to 20:1). Other ranges are also possible.

An aged non-woven fiber web impregnated with an aerogel precursor may be dried for any of a variety of suitable time periods. In some embodiments, a non-woven fiber web is dried for a period of greater than or equal to 15 minutes, greater than or equal to 30 minutes, greater than or equal to 45 minutes, greater than or equal to 60 minutes, greater than or equal to 90 minutes, or greater than or equal to 2 hours. In some embodiments, a non-woven fiber web is dried for a period of less than or equal to 12 hours, less than or equal to 8 hours, less than or equal to 6 hours, less than or equal to 4 hours, less than or equal to 3 hours, or less than or equal to 2 hours. Combinations of these ranges are also possible (e.g., greater than or equal to 15 minutes and less than or equal to 12 minutes). Other ranges are also possible.

An aged non-woven fiber web impregnated with an aerogel precursor may be dried at any of a variety of temperatures. In some embodiments, a non-woven fiber web is dried at a temperature of greater than or equal to 80° C., greater than or equal to 85° C., greater than or equal to 90° C., greater than or equal to 95° C., greater than or equal to 95° C., greater than or equal to 100° C., greater than or equal to 105° C., or greater than or equal to 110° C. In some embodiments, a non-woven fiber web is dried at a temperature of less than or equal to 130° C., less than or equal to 125° C., less than or equal to 120° C., less than or equal to 115° C., less than or equal to 110° C., or less than or equal to 105° C. Combinations of these ranges are also possible (e.g., greater than or equal to 80° C. and less than or equal to 130° C.). Other ranges are also possible.

An aerogel precursor may comprise one or more aerogel-forming reagents which may react to form an aerogel. In some embodiments, the aerogel-forming reagent(s) may undergo a sol-gel reaction to form the aerogel. As a first step, the aerogel precursor may be converted into a sol by reaction. Then, the sol may react to form the aerogel. As described above, it is possible for the aerogel precursor and/or the sol to be introduced into a non-woven fiber web prior to the reaction to form the aerogel and/or a fully-formed aerogel may be introduced into a non-woven fiber web. In some embodiments, an aerogel precursor and/or a sol is introduced into a non-woven fiber web while dissolved and/or suspended in a solvent, such as ethanol.

Sol-gel reactions employed to form aerogels may comprise hydrolysis and/or cross-linking. An aerogel-forming reagent may be and/or include a metal alkoxide having the formula M(OR)ₓ, where M is Al, Si, or Ti, and R is an alkyl group (e.g., a methyl group, an ethyl group, a propyl group, a butyl group). Generally, when M is Al, x=3; when M is Si, x=4; and when M is Ti, x=4. An aerogel-forming reagent may be and/or comprise a species configured to react with a metal alkoxide, such as water. In one non-limiting example, the aerogel-forming reagents comprise tetraethyl orthosilicate (TEOS) and water. In such embodiments, the reaction of TEOS and water would produce a silica aerogel and ethanol. This reaction is shown schematically below:

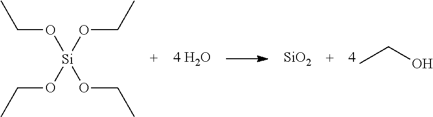

The above reaction may be performed using an acidic catalyst or a basic catalyst. As another non-limiting example, in some embodiments aerogel-forming reagents comprise tetraethyl orthosilicate (TEOS), alkyltriethoxysilane (RSi(OC₂H₅)₃), and water. In the alkyltriethyoxysilane, R may be an alkyl group (e.g., a methyl group, an ethyl group, a propyl group, and/or a butyl group). The reaction of TEOS, RSi(OC₂H₅)₃, and water may be performed using an acidic catalyst or a basic catalyst. The reaction of TEOS, RSi(OC₂H₅)₃, and water may produce ethanol and a silica hybrid aerogel having the formula (SiO₂)ₓ(RSiO_{1.5})_{y}.

Non-woven fiber webs as described herein may be used in any of a variety of suitable batteries. Generally, a battery comprises a plurality of electrochemical cells, including a first electrochemical cell and a second electrochemical cell. In each electrochemical cell, electrons may pass from a first battery plate (e.g., a negative battery plate) to a second battery plate (e.g., a positive battery plate) during discharge and from the second battery plate to the first battery plate during charge. Positively charged ions may also flow through the electrochemical cell during each of these processes in the direction opposite to the direction of electron flow. Each electrochemical cell may further comprise an electrolyte configured to transport these ions. As described above, the batteries described herein may further comprise a non-woven fiber web described herein between some of the pairs of electrochemical cells. Such non-woven fiber webs may be particularly suitable for thermally insulating the electrochemical cells from each other.

In some embodiments, a battery described herein comprises a plurality of lithium metal electrochemical cells and/or lithium-ion electrochemical cells. In such embodiments, lithium ions may be the positive ions that are transported between electrodes during charging and discharging. Without wishing to be bound by any particular theory, it is believed that such batteries may be particularly prone overheating during use, and so may especially benefit from the inclusion of the thermal insulation that may be provided by a non-woven fiber web as described herein.

Generally, the batteries described herein comprise a plurality of electrochemical cells and a non-woven fiber web. In some embodiments, a battery comprises greater than or equal to 2, greater than or equal to 3, greater than or equal to 5, greater than or equal to 10, greater than or equal to 15, greater than or equal to 20, greater than or equal to 30, or greater than or equal to 50 electrochemical cells. In some embodiments, a battery comprises less than or equal to 250, less than or equal to 225, less than or equal to 200, less than or equal to 175, less than or equal to 150, less than or equal to 125, less than or equal to 100, less than or equal to 75, less than or equal to 50, or less than or equal to 25 electrochemical cells. Combinations of these ranges are also possible (e.g., greater than or equal to 2 and less than or equal to 250, greater than or equal to 3 and less than or equal to 100, or greater than or equal to 5 and less than or equal to 1 electrochemical cells). Other ranges are also possible.

In some embodiments, at least some pairs of nearest neighbor electrochemical cells of the battery are separated from one another by the non-woven fiber web. In some embodiments greater than or equal to 1%, greater than or equal to 5%, greater than or equal to 10%, greater than or equal to 20%, greater than or equal to 50%, greater than or equal to 80%, or greater than or equal to 90% of pairs of nearest neighbor electrochemical cells are separated from one another by a non-woven fiber web. In some embodiments, less than or equal to 100%, less than or equal to 90%, less than or equal to 80%, or less than or equal to 50% of pairs of nearest neighbor electrochemical cells are separated from one another by a non-woven fiber web. Combinations of these ranges are also possible (e.g., greater than or equal to 1% and less than or equal to 100%, greater than or equal to 5% and less than or equal to 90%, or greater than or equal to 20% and less than or equal to 80% of pairs of nearest neighbor electrochemical cells are separated from one another by a non-woven fiber web). Other ranges are also possible.

The following examples are intended to illustrate some embodiments of the present disclosure, but do not exemplify the full scope of the disclosure.

### EXAMPLE 1

This Example describes the preparation and selected properties of several non-woven fiber webs.

The non-woven fiber webs were fabricated by a wet laid process. The fibers to be included in the non-woven fiber web were first dispersed in water to form a wet stock. These fibers were staple glass fibers, ECR-glass fibers, and synthetic bicomponent PE/PET binder fibers. Next, the wet stock was transferred into a tank. Water was filtered from the bottom of the tank, producing a wet non-woven fiber web. The wet non-woven fiber web was further filtered under vacuum and then put onto a photo drier (with a surface temperature of 100° C.) for 2 hours to remove all remaining water. The dry non-woven fiber web was then placed in an oven containing air and held in a 150° C. oven for 3 minutes to activate the bicomponent fibers, binding the bicomponent fibers to the glass fibers. Five non-woven fiber webs (referred to herein as Web 1, Web 2, Web 3, Web 4, and Web 5) were prepared, each comprising different relative amounts of each fiber type. Table 1 provides the relative amount and selected average dimensions of each fiber type used in Webs 1-5.

TABLE 1
Composition and properties of non-woven fiber webs.

| | | | | |
|---|---|---|---|---|
| Web 1 | Web 2 | Web 3 | Web 4 | Web 5 |

Fiber Types

| | | | | | |
|---|---|---|---|---|---|
| ECR-glass Fibers (wt %) | 10 | 10 | 25 | 50 | 65 |
| Staple Glass Fibers (wt %) | 75 | 80 | 65 | 40 | 25 |
| Bicomponent Fibers (wt %) | 15 | 10 | 10 | 10 | 10 |

Fiber Properties

| | | | | | |
|---|---|---|---|---|---|
| Average Diameter of Staple Glass | 8.5 | 3.7 | 3.7 | 3.7 | 3.7 |
| Fibers (microns) | | | | | |
| Average Diameter of ECR-Glass Fibers | 13.5 | 7.0 | 7.0 | 7.0 | 7.0 |
| (microns) | | | | | |
| Average Diameter of Bicomponent | 13.0 | 13.0 | 13.0 | 13.0 | 13.0 |
| Fibers (microns) | | | | | |
| Average Length of Staple Glass Fibers | 1.79 | 1.81 | 1.81 | 1.81 | 1.81 |
| (mm) | | | | | |
| Average Length of ECR-Glass Fibers | 12.0 | 6.0 | 6.0 | 6.0 | 6.0 |
| (mm) | | | | | |
| Average Length of Bicomponent Fibers | 12 | 6 | 6 | 6 | 6 |
| (mm) | | | | | |

Physical Properties

| | | | | | |
|---|---|---|---|---|---|
| Basis Weight (g/m²) | 96 | 105 | 105 | 107 | 110 |

### EXAMPLE 2

This Example describes the shrinkage upon heating of the non-woven fiber webs described in Example 1.

Two 100 mm×100 mm samples were cut from each non-woven fiber web described in Example 1. Each sample was placed into an oven containing air that had been pre-heated to a temperature of 800° C. or 850° C. and kept there for 10 min. Then, each sample was removed from the oven and allowed to cool to room temperature in room temperature air. Then, the dimensions of the samples were measured again. Additionally, the morphology of each sample was inspected under scanning electron microscope (SEM).

Table 2 shows the dimensions of each sample after heating. Webs 1-3, which comprised only small quantities of ECR-glass fibers, lost dimensional integrity at 850° C. and could not be measured. Generally, the linear shrinkage of each non-woven fiber web was reduced by the addition of more ECR-glass fibers. Every sample experienced shrinkage after heating.

TABLE 2
Dimensions of non-woven fiber webs after heating.
All webs had initial dimensions of 100 × 100.

| | Dimensions After Heating (mm × mm) | | | | |
|---|---|---|---|---|---|
| | Web 1 | Web 2 | Web 3 | Web 4 | Web 5 |
| 10 minutes at 800° C. | 81 × 78 | 82 × 83 | 90 × 90 | 96 × 96 | 98 × 99 |
| 10 minutes at 850° C. | — | — | — | 91 × 92 | 95 × 94 |

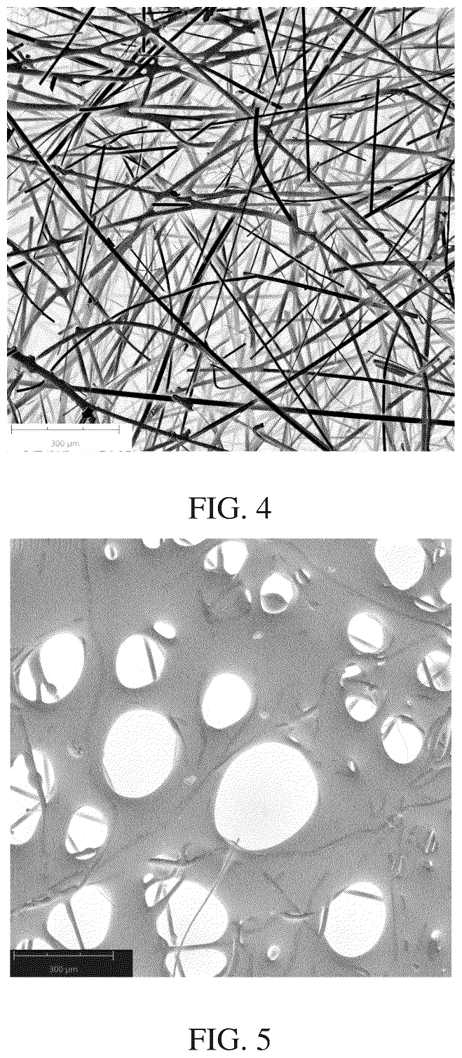

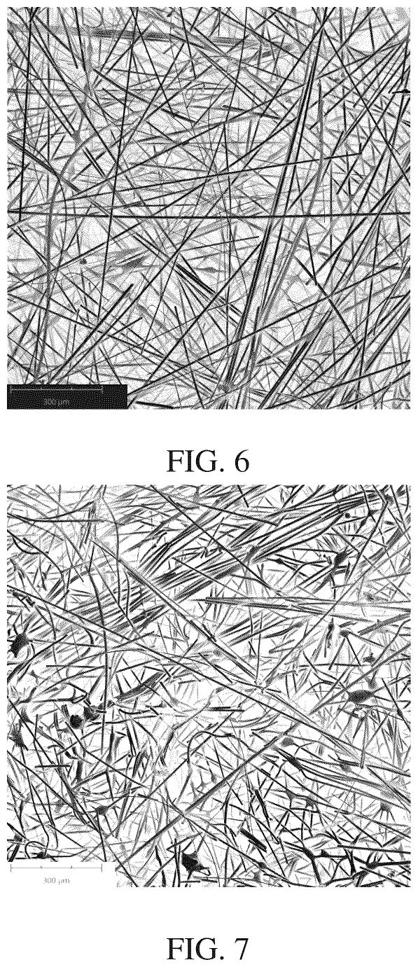

SEM images suggested that the shrinkage resulted from softening of the staple glass fibers, which then flowed together and appreciably lost their fibrous nature. FIGS. 4-5 are representative SEM images of Web 1 before and after heating to 800° C., respectively. FIGS. 6-7 are representative SEM images of Web 5 before and after heating to 850° C., respectively. FIG. 5 depicts significant softening of the staple glass fibers. However, although some evidence of softening is visible in FIG. 7, generally, the morphology of Web 5 after heating was relatively similar to the initial morphology shown in FIG. 6.

These results demonstrate that inclusion of high softening point fibers in an amount of at least 50 wt % can significantly reduce shrinkage and prevent softening of a non-woven fiber web, and can advantageously increase a temperature at which the non-woven fiber web can act as an effective thermal insulator for battery applications.

### EXAMPLE 3

This Example describes the preparation and selected properties of several non-woven fiber webs.

The fibers to be included in the non-woven fiber web were first dispersed in water to form a wet stock. These fibers were staple glass fibers, ECR-glass fibers, and synthetic bicomponent PE/PET binder fibers. The non-woven fiber webs were fabricated by a wet laid process using a paper-making machine. Five non-woven fiber webs (referred to herein as Web 6, Web 7, Web 8, Web 9, and Web 10) were prepared. Table 3 provides the relative amount and selected average dimensions of each fiber type used in Webs 6-10, and lists various properties of the non-woven fiber webs.

TABLE 3
Composition and properties of non-woven fiber webs.

| | | | | |
|---|---|---|---|---|
| Web 6 | Web 7 | Web 8 | Web 9 | Web 10 |

Fiber Types

| | | | | | |
|---|---|---|---|---|---|
| ECR-Glass Fibers (wt %) | 10 | 60 | 60 | 60 | 60 |
| Staple Glass Fibers (wt %) | 75 | 30 | 30 | 30 | 30 |
| Bicomponent Fibers (wt %) | 15 | 10 | 10 | 10 | 10 |

Fiber Properties

| | | | | | |
|---|---|---|---|---|---|
| Average Diameter of Staple Glass | 8.5 | 2.1 | 2.1 | 3.7 | 3.7 |
| Fibers (microns) | | | | | |
| Average Diameter of ECR-Glass | 13.5 | 7.0 | 7.0 | 7.0 | 7.0 |
| Fibers (microns) | | | | | |
| Average Diameter of Bicomponent | 13.0 | 13.0 | 13.0 | 13.0 | 13.0 |
| Fibers (microns) | | | | | |
| Average Length of Staple Glass | 1.79 | 1.24 | 1.24 | 1.81 | 1.81 |
| Fibers (mm) | | | | | |
| Average Length of ECR-Glass | 12.0 | 6.0 | 6.0 | 6.0 | 6.0 |
| Fibers (mm) | | | | | |
| Average Length of Bicomponent | 12.0 | 6.0 | 6.0 | 6.0 | 6.0 |
| Fibers (mm) | | | | | |

Physical Properties

| | | | | | |
|---|---|---|---|---|---|
| Basis Weight (g/m²) | 158 | 127 | 255 | 126 | 243 |

### EXAMPLE 4

This Example describes the shrinkage upon heating of the non-woven fiber webs described in Example 3.

Samples were cut from each non-woven fiber web described in Example 3. Each sample was placed into an oven containing ambient air that had been pre-heated to a temperature of 800° C. and kept there for 10 min. Then, each sample was removed from the oven and allowed to cool to room temperature in room temperature air. Then, the dimensions of the samples were measured again.

Table 4 shows the dimensions of each sample after heating. Web 6, which comprised only 10 wt % high softening point ECR-glass fibers, experienced shrinkages of 13.9% and 23.7% in the cross direction (CD) and the machine direction (MD), respectively. On the other hand, Webs 7-10, comprised 60 wt % high softening point ECR-glass fibers, and experienced shrinkages of less than or equal to 3% in both the CD and the MD.

TABLE 4
Initial and final dimensions of non-woven fiber webs after heating.

| | Dimensions (CD × MD, in mm) | | | | |
|---|---|---|---|---|---|
| | Web 6 | Web 7 | Web 8 | Web 9 | Web 10 |
| Before | 101 × 127 | 101 × 127 | 101 × 127 | 101 × 127 | 101 × 127 |
| Heating | | | | | |
| After 10 | 87 × 97 | 99.5 × 126 | 99 × 125 | 98 × 125 | 99 × 125 |
| minutes | | | | | |
| at 800° C. | | | | | |

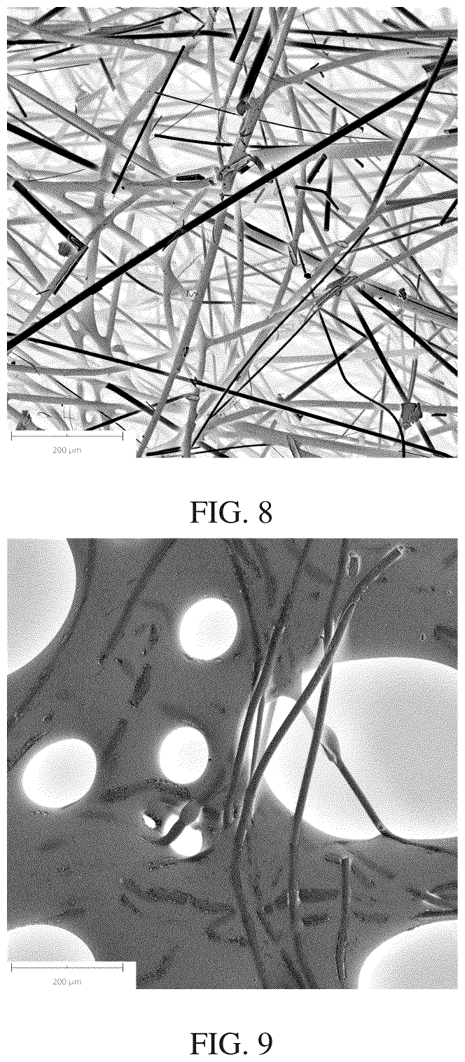

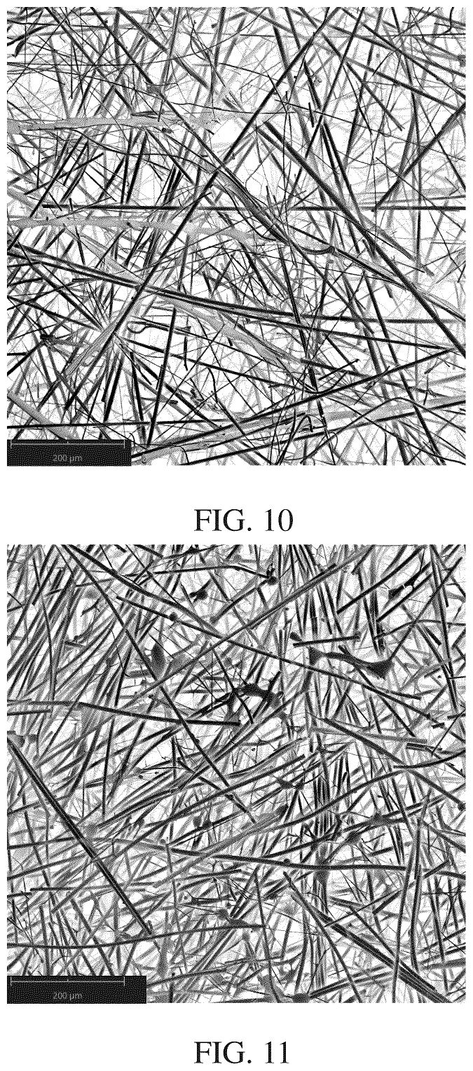

SEM images suggested that the shrinkage resulted from softening of the staple glass fibers, which then flowed together and appreciably lost their fibrous nature. FIGS. 8-9 are representative SEM images of Web 6 before and after heating to 800° C., respectively. FIGS. 10-11 are representative SEM images of Web 7 before and after heating to 800° C., respectively. FIG. 9 depicts significant softening. FIG. 11 depicts minimal softening, and the morphology of Web 7 after heating was relatively similar to the initial morphology shown in FIG. 10.

These results demonstrate that inclusion of high softening point fibers in an amount of at least 50 wt % can significantly reduce shrinkage and prevent softening of a non-woven fiber web, and can advantageously increase a temperature at which the non-woven fiber web can act as an effective thermal insulator for battery applications.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A battery, comprising:
a plurality of electrochemical cells comprising a first electrochemical cell and a second electrochemical cell; and
a non-woven fiber web positioned between the first and second electrochemical cells, wherein:
the non-woven fiber web comprises glass fibers;
the glass fibers comprise high softening point fibers that comprise less than or equal to 0.8 wt % Na₂O and/or less than or equal to 0.8 wt % K₂O;
the high softening point fibers make up greater than or equal to 30 wt % of the glass fibers;
the glass fibers make up greater than 80 wt % of the non-woven fiber web; and
the glass fibers have an average length that is greater than or equal to 0.5 mm and less than or equal to 7 mm.

2. A battery, comprising:
a plurality of electrochemical cells comprising a first electrochemical cell and a second electrochemical cell; and
a wet laid non-woven fiber web positioned between the first and second electrochemical cells, wherein:
the non-woven fiber web comprises glass fibers;
the glass fibers comprise high softening point fibers that comprise that comprise less than or equal to 0.8 wt % Na₂O and/or less than or equal to 0.8 wt % K₂O; and
the high softening point fibers make up greater than or equal to 30 wt % of the glass fibers; and
the glass fibers make up greater than 80 wt % of the non-woven fiber web.

3. A battery, comprising:
a plurality of modules comprising a first module and a second module; and
a non-woven fiber web positioned between the first and second modules, wherein:
the non-woven fiber web comprises glass fibers;
the glass fibers comprise high softening point fibers that comprise less than or equal to 0.8 wt % Na₂O and/or less than or equal to 0.8 wt % K₂O;
the high softening point fibers make up greater than or equal to 30 wt % of the glass fibers;
the glass fibers make up greater than 80 wt % of the non-woven fiber web; and
the glass fibers have an average length that is greater than or equal to 0.5 mm and less than or equal to 7 mm.

4. (canceled)

5. The battery of claim 3, wherein each of the first and second modules comprises a plurality of electrochemical cells.

6. The battery of claim 1, wherein the non-woven fiber web has a total thickness of less than or equal to 3.5 mm.

7. The battery of claim 1, wherein the non-woven fiber web has a thermal conductivity of less than or equal to 70 mW/K-m.

8. The battery of claim 1, further comprising a fire retardant.

9. The battery of claim 8, wherein the fire retardant comprises a hydroxide, a carbonate, a phosphor-containing compound, and/or an organic halide compound.

10. (canceled)

11. The battery of claim 8, wherein the fire retardant releases water and/or carbon dioxide upon exposure to heat.

12. The battery of claim 1, further comprising an aerogel.

13. The battery of claim 12, wherein the aerogel is a silica aerogel or a silica hybrid aerogel having the formula (SiO₂)ₓ(RSiO_{1.5})_{y}, where R is a methyl group, an ethyl group, a propyl group, and/or a butyl group.

14. The battery of claim 1, wherein the glass fibers comprise chopped strand glass fibers.

15. The battery of claim 1, wherein the glass fibers comprise staple glass fibers.

16-17. (canceled)

18. The battery of claim 1, wherein the glass fibers have an average diameter of greater than or equal to 1 micron and less than or equal to 12 microns.

19. The battery of claim 1, wherein K₂O makes up less than or equal to 0.5 wt % of the high softening point fibers and/or Na₂O makes up less than or equal to 0.5 wt % of the high softening point fibers.

20. (canceled)

21. The battery of claim 1, wherein the non-woven fiber web further comprises multicomponent fibers.

22. The battery of any preceding claim, wherein the multicomponent fibers are bicomponent fibers.

23. (canceled)

24. The battery of claim 1, wherein the non-woven fiber web exhibits a shrinkage of less than or equal to 15% in the machine direction and a shrinkage of less than or equal to 15% in the cross direction when retained in an 800° C. oven for 10 minutes.

25. The battery of claim 1, wherein the battery is a lithium-ion battery.

26. The battery of claim 1, wherein the high softening point fibers have a softening point greater than or equal to 800° C.
